(19) United States
(12) Patent Application Publication
(10) Pub. No.: US 2016/0320058 A1
(43) Pub. Date: Nov. 3, 2016

(54) Method and apparatus for controlling combustion in a furnace

(71) Applicant: AALTO UNIVERSITY FOUNDATION, Aalto (FI)

(72) Inventor: Jukka Kortela, Espoo (FI)

(21) Appl. No.: 15/104,996

(22) PCT Filed: Dec. 17, 2014
(86) PCT No.: PCT/FI2014/051022

§ 371 Date: Jun. 16, 2016

Related U.S. Application Data
(60) Provisional application No. 61/916,810, filed on Dec. 17, 2013.

(51) Int. Cl. F23N 5/00; G05B 15/02; F23G 5/50; F23N 5/26; F23N 5/24

(52) U.S. Cl. CPC F23N 5/003; F23N 5/265; F23N 5/242; F23G 5/50; G05B 15/02; F23N 2023/08; F23N 2023/48; F23N 2025/02; F23N 2025/26; F23N 2039/02

(57) ABSTRACT

This paper presents a model predictive control (MPC) strategy for BioGrate boiler, compensating the main disturbances caused by variations in fuel quality such as the moisture content of fuel, and variations in fuel flow. The MPC utilizes models, the fuel moisture soft-sensor to estimate water evaporation, and the fuel flow calculations to estimate the thermal decomposition of dry fuel, to handle these variations, the inherent large time constants, and long time delays of the boiler. The MPC strategy is compared with the method currently used in the BioPower 5 CHP plant. Finally, the results are presented, analyzed and discussed.

### TECHNICAL FIELD

The present invention concerns method for controlling combustion in a boiler using solid fuel.

Especially the invention concerns method for controlling combustion in a boiler that uses solid fuels that have a varying moisture content, for example bio fuels.

### BACKGROUND

The combustion of biomass is increasing due to a demand to increase the portion of renewable energy in total energy production. Biomass with a moisture content up to 65% can be burned in BioGrate developed by MW Power. However, although this system's design is technically mature, the currently used control strategies need further improvement to utilize the possibilities provided by recent developments in control theory [1]. An important prerequisite in the MPC strategy development for BioGrate has been to develop a biomass combustion model and methods for estimating fuel moisture content, thermal decomposition of fuel, and combustion power, as this system is characterized by the long time delays and large time constants [2][3].

To improve the current used control strategies it is important to understand how combustion happens in BioGrate. Several models for biomass combustion have been developed. Saastamoinen et al. [4] studied the effects of air flow rate, fuel moisture content, particle size, bed density, and wood type. The study showed that moisture considerable lowered the speed of the ignition front.

Johansson et al. [5] investigated the effect of using a porous media approximation in modeling fixed bed combustion of wood. They compared the results from the model that uses the approximation with the results from the model, where the internal particle gradients are taken into account. The results show that when the particle size is larger than 2 cm, the reaction front is wider when internal particle gradients are considered. Moreover, the approximation can play a greater role when the gas stoichiometry in the reaction front is of importance.

Yang et al. [6] carried out detailed mathematical simulations as well as experiments with a porous model for the combustion of wood chips and the incineration of simulated municipal solid wastes in a bench-top stationary bed. They concluded that ignition time is influenced by both the devolatilization kinetic rate and the moisture level of the fuel: An increase in the moisture level prolongs the ignition time. Moreover, an increase in the fuel moisture level shifts the combustion stoichiometry to a fuel-lean condition. Yang et al. [7] employed mathematical models of a packed bed system to simulate the effects of changes in four different fuel properties on combustion characteristics in terms of combustion rate, combustion stoichiometry, flue gas composition, and solid-phase temperature. They showed that the combustion rate is determined by both the fuel particle size and the fuel density: Smaller fuel particle sizes result in higher combustion rates due to increased reaction surface area and enhanced gas-phase mixing in the bed. And even at different primary air levels, the burning rate decreases as biomass material density increases. In [8], Yang et al further investigated especially the effect of particle size on pinewood combustion in a packed bed. They concluded that both char burnout and fuel devolatilization occur at the same time in a bed of large particles.

Most combustion experiments have been done using a stationary bed and with combustion started on the upper surface of the fuel bed. Thunman and Leckner [9] however studied combustion of wet biofuels in a 31 MW reciprocating grate furnace. In addition, they performed other experiments in batch-fired pot furnaces. The fuel was forest waste with a moisture content of approximately 50%. Thunman and Leckner concluded that ignition of wet biofuel has to take place on the surface of the grate, for example, by means of heat conduction through the grate bars. In such a case, heat is generated at the bottom of the bed by char combustion and is transferred along with gas up through the bed, which dries and devolatilizes fresh fuel with a moisture content of up to 70 or 80%. In the case of a counter-current, which is ignited from the top, such a moisture content would be too high, however, since devolatilization and combustion in a counter-current take place on a narrow front. Thunman and Leckner further compared co-current and counter-current fixed bed combustion of biofuel in [10]. The results show that in a steady state, drying, devolatilization, and char combustion are separated in co-current combustion, whereas the three stages are in closer proximity during the entire counter-current combustion process.

Based on the insight gained into the basic combustion situation by Bauer et al. [1], they derived a simple model for co-current combustion of biomass based on two mass balances for water and dry fuel. The model was verified by experiments at a pilot scale furnace with a horizontally moving grate. The test results showed that the overall effect of the primary air flow rate on the thermal decomposition of dry fuel is multiplicative. This is also shown in the results of Yang et al. [8] and Friber et al. when the air factor is not much larger than stoichiometric air, staying at a typical optimal level of about 1.2 to 1.7. Higher air flows begin to cool the bed [11]. In addition, the test results of Bauer et al. [1] showed that the rate of water evaporation is mainly independent of the primary air flow. As shown in the theoretical studies and the tests by Kortela and Lautala [12], thermal decomposition of fuel and combustion power can be calculated on the basis of the furnace's oxygen consumption. To estimate water evaporation, Kortela and Jämsä-Jounela [13] developed a fuel moisture soft sensor based on the dynamic model that makes use of combustion power estimates and that makes use of the model of the secondary superheater. There is however a need for more accurate prediction of combustion power.

Based on the combustion situation in the BioGrate boiler, it is assumed this is co-current combustion. This application presents a model predictive control (MPC) strategy for BioGrate boiler. The specification of the application presents the BioPower 5 CHP plant process, MPC strategy and the models of the fuel bed height and thermal decomposition of dry fuel, and fuel and moisture soft-sensors. Lastly, the test results are presented, followed by the conclusions.

### SUMMARY OF INVENTION

As discussed above, there is need to improve the control of combustion process in order to predict the combustion power more accurately.

Further, there is need to take the changes in moisture content of the fuel into account more accurately.

For the above reasons, it would be beneficial to provide a method for estimating and controlling of combustion power in boilers using at least one type of solid fuel having varying moisture content.

In a first aspect, the invention relates to a method for compensating disturbances caused by variation in at least one of a fuel quality and a fuel bed of a boiler.

One embodiment of the invention relates to providing a fuel moisture soft sensor for deducting water evaporation for estimating the changes in the fuel moisture.

According to other aspects and embodiments of the present invention, the invention provides method for reducing variations in drum pressure of the boiler.

According to one further aspect of the invention, the invention provides fast response to the changes in steam demand.

According to further one aspect of the invention, the invention provide a strategy for utilizing fuel and moisture soft sensors to estimate the burning fuel at the time moment and the water evaporation rate respectively.

According to one aspect of the invention, the purpose is to design an overall FTMPC scheme capable of compensating the fuel quality variations and the fuel bed height sensor fault in the BioPower 5 CHP process.

One aspect or embodiment of the invention aims to development of a method for fuel moisture content estimation and combining it with the combustion power estimation.

Further aspects and embodiments aim to development of models for the BioGrate boiler, development of a fault tolerant MPC for the BioPower 5 CHP process.

The invention is based on a method, comprising:

receiving sensor input concerning a thermal decomposition rate and a water evaporation of fuel moisture;
based at least in part on the sensor input and a mathematical model, modelling a performance of a boiler, and
determining, based at least in part on the modelling, control instructions to control functioning of the boiler, the control instructions being configured to cause compensation for disturbances caused by variations in at least one of a fuel quality and a fuel bed in the boiler.

According to one embodiment of the invention, the control instructions are configured to cause controlling of at least one of a primary air supply and a stoke speed, when supplied to the boiler.

According to one the control instructions are configured to cause controlling of a secondary air supply.

According to one further embodiment of the invention the modelling comprises determining a fuel bed height, and the determining comprises determining control instructions that increase the primary air supply responsive to a determination that a fuel bed height in the boiler has increased.

Further, according to the control instructions are determined, based on the modelling, to cause controlling of the primary air supply to keep a fuel bed height at a desired level.

Embodiments of the invention include alternatives wherein the determining is based at least in part on at least one of a target fuel bed height, a target steam pressure and a target combustion power.

One embodiment of the invention includes steps wherein the modelling the fuel bed height is determined based on a first equation where a time derivative of the thermal decomposition rate is equal to a time derivative of a primary air flow rate multiplied by a thermal decomposition rate coefficient, from which a dry biomass multiplied by a fuel bed height coefficient is subtracted to obtain the time derivative of the thermal decomposition rate.

According to one embodiment, a fuel bed height is obtained from at least one pressure sensor and from the modelling based on a primary air supply rate independently of each other.

Further, embodiments of the invention may comprise determining whether the pressure sensor has malfunctioned based on a comparison of the fuel bed height obtained from the pressure sensor to the fuel bed height obtained from the modelling.

According to one embodiment, after determination of water evaporation, estimating the amount of moisture in boiler so that the moment when the moisture begins to evaporate on the boiler can be estimated.

According to one the effect of evaporating moisture in relation to power produced is deducted and at least one of the stoker speed and primary air feed is controlled accordingly.

The embodiments of the invention also include apparatus for realizing the features of the method as well as a power plant comprising such an apparatus, a non-transitory computer readable medium having stored thereon a set of computer readable instructions that, when executed by at least one processor, cause an apparatus to perform features of the invention and finally a computer program configured to cause the method.

Various embodiments of the invention provide essential benefits relating to speed of the control, accuracy and reliability. For example, availability and profitability of the BioPower 5 CHP process are improved by integration of fuel moisture content and combustion power estimations into a fault-tolerant model predictive control (FTMPC) scheme.

These features are discussed below in the detailed description of the invention.

Other objects and features of the invention will become apparent from the following detailed description considered in conjunction with the accompanying drawings. It is to be understood, however, that the drawings are intended solely for purposes of illustration and not as a definition of the limits of the invention, for which reference should be made to the appended claims.

### DESCRIPTION OF DRAWINGS

FIG. 1 shows a boiler in which the invention can be utilized.

FIG. 2 illustrates the boiler of the BioPower 5 CHP plant of FIG. 1.

FIG. 3 depicts a current control strategy of the BioPower plant of FIGS. 1 and 2.

FIG. 4 depicts a model predictive control according to an embodiment of the invention for a plant of FIG. 2.

FIG. 5 illustrates configuration of the models for realizing embodiments of the invention.

FIG. 6 is a schematic diagram of thermal decomposition of fuel.

FIG. 7 shows schematically the placement of pressure sensors in the grate of boiler of FIGS. 1 and 2.

FIG. 8 depicts model variables in the identification.

FIG. 10 is a diagram of thermal decomposition in relation to primary air with different fuel bed pressures.

FIG. 11 shows the reactions of the system according to the embodiment of the invention to changes in moisture content of the fuel flow.

FIG. 12 shows the reactions of the present system to changes in moisture content of the fuel flow.

FIG. 13 shows the reactions of the system according to the embodiment of the invention to changes in electricity and hot water demand.

FIG. 14 is a comparison of the present system to features in FIG. 13.

In the following the invention is described in more detail by using a Biopower 5 CGP plant as example. The invention may be utilized also in other solid fuel boilers or furnaces such as grate furnaces, circulating fluidized bed furnaces or bubbling fluidized bed furnaces.

### DESCRIPTION OF THE PROCESS AND ITS CONTROL STRATEGY

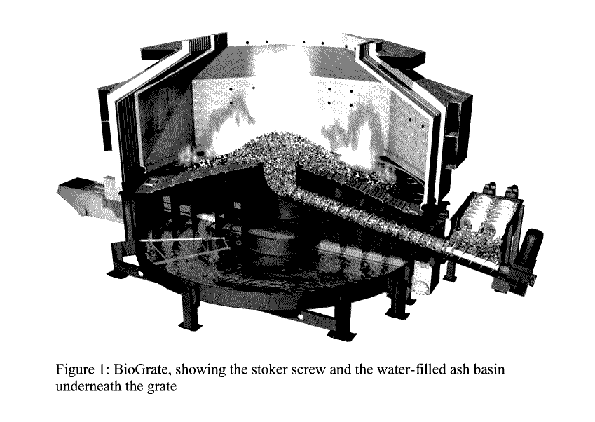

In the BioPower 5 CHP plant, heat for electricity generation and hot water network is obtained by direct combustion of solid biomass—bark and woodchips—which is fed into the BioGrate together with combustion air (FIG. 1).

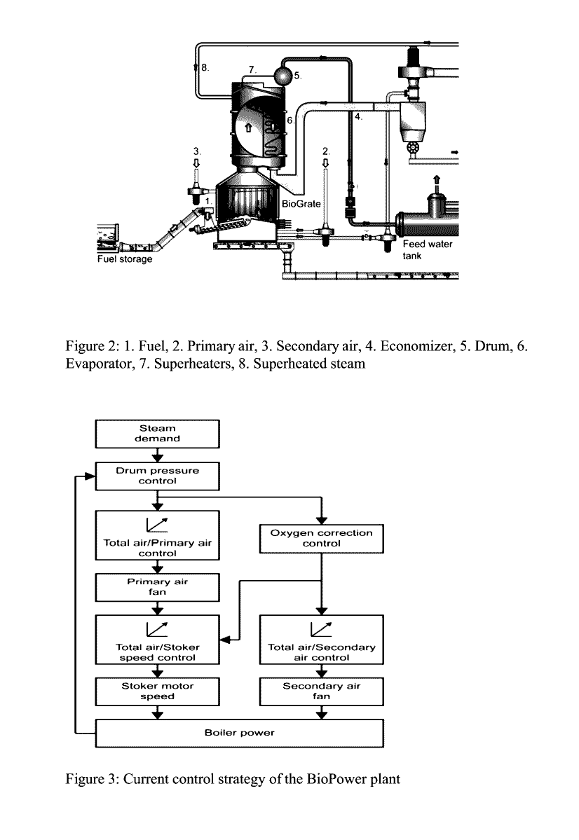

FIG. 2 illustrates the boiler of the BioPower 5 CHP plant. The essential components of the boiler are an economizer, an evaporator, a drum, and primary and secondary superheaters. Feed water is pumped into the boiler from a feed water tank. The water is first led into the economizer (4), which is heated by means of flue gases.

From the economizer, the heated feed water is led into the drum (5) and along downcomers into the bottom of the evaporator (6) tubes that surround the boiler. From the evaporator tubes, the heated water and steam return back into the steam drum, where they are separated. The temperature of steam is risen in primary and secondary superheaters (7) and then the superheated high-pressure steam (8) is led into a steam turbine, where electricity is generated.

### Current Control Strategy of the BioPower Plant

The main objective of the BioPower plant is to produce a desired amount of energy by keeping the drum pressure constant. The necessary boiler power is produced by manipulating primary air, secondary air, and stoker speed as illustrated in FIG. 3.

The fuel feed is controlled by manipulating the motor speed of the stoker screw to track the primary air flow measurement. The necessary amount of primary air and secondary air for diverse power levels are specified by air curves. The set point of the secondary air controller is adjusted by the flue gas oxygen controller to provide excess air for combustion and enable the complete combustion of fuel.

### Model Predictive Control for the BioPower 5 CHP Plant

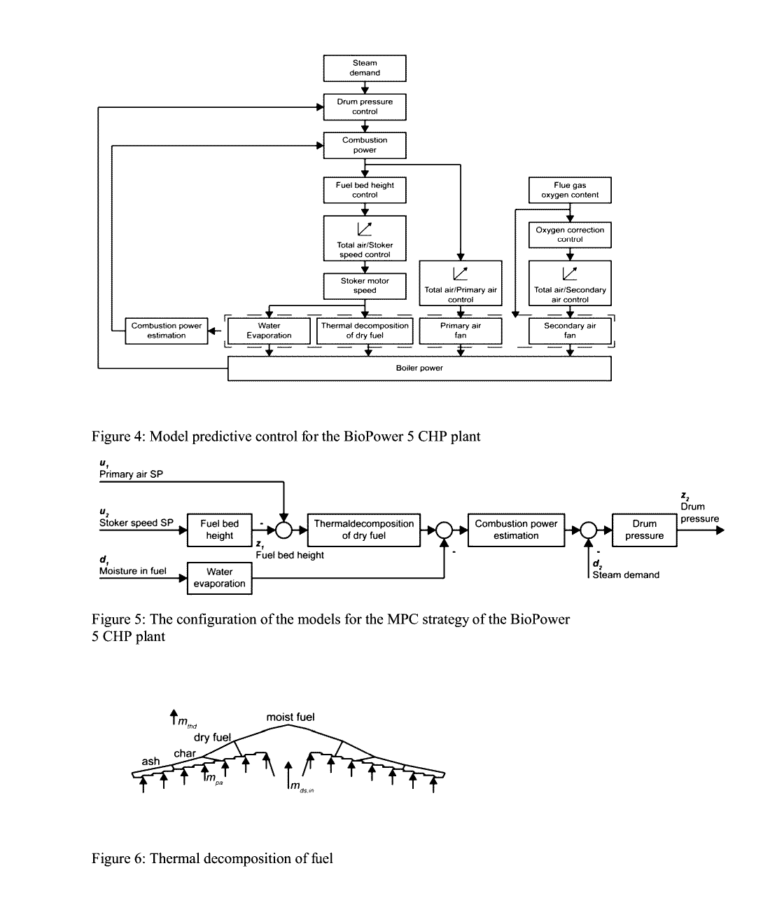

The MPC strategy according to the embodiments of the invention over the current control strategy is illustrated in FIG. 4. The proposed strategy utilizes fuel and moisture soft-sensors to estimate the burning fuel at the time moment and the water evaporation rate respectively. Subsequently, the combustion power is estimated based on these fuel-moisture soft sensors. As a result, the required amount of combustion power from the boiler can be produced, which is done by manipulating the primary air and the stoker speed. In addition, this combustion power can be accurately predicted.

### MPC for the BioGrate Boiler

The MPC manipulates separately both primary air flow rate and stoker speed, as illustrated in FIG. 5. The models of the MPC are configured as follows: The primary air flow rate and stoker speed (u) are the manipulated variables; the moisture content in the fuel feed and the steam demand are the measured disturbances (d); and the fuel bed height and the steam pressure are the controlled variables (z). The MPC utilizes the linear state space system [14]:

xₖ₊₁=Axₖ+Buₖ+Edₖ

zₖ=C_{z}xₖ (1)

### Regulator

The system of Equation (1) can be formulated as

$${z}_{k} = {C}_{z} {A}^{k} {x}_{0} + {\sum }_{j = 0}^{k - 1} {H}_{k - j} {u}_{j} \qquad ( 2 )$$

where Hₖ₋ⱼ are impulse response coefficients. Using the Equation (2), the MPC optimization problem with input, the input rate of movement, and output constraints is thus:

$$min φ = \frac{1}{2} {\sum }_{k = 1}^{N} {‖ {z}_{k} - {r}_{k} ‖}_{{Q}_{z}}^{2} + \frac{1}{2} {‖ Δ {u}_{k} ‖}_{S}^{2} \\ s . t . {x}_{k + 1} = {Ax}_{k} + {Bu}_{k} + {Ed}_{k} , k = 0 , 1 , … , N - 1 \\ {z}_{k} = {C}_{z} {x}_{k} , k = 0 , 1 , … , N \\ {u}_{min} \leq {u}_{k} \leq {u}_{max} , k = 0 , 1 , … , N - 1 \\ Δ {u}_{min} \leq Δ {u}_{k} \leq Δ {u}_{max} , k = 0 , 1 , … , N - 1 \\ {z}_{min} \leq {z}_{k} \leq {z}_{max} , k = 1 , 2 , … , N \qquad ( 3 )$$

where •uₖ=uₖ−uₖ₋₁. For the horizon N, the Z, R, and U are formulated as follows:

$$Z = [ \begin{matrix}{z}_{1} \\ {z}_{2} \\ ⋮ \\ {z}_{N}\end{matrix} ] , R = [ \begin{matrix}{r}_{1} \\ {r}_{2} \\ ⋮ \\ {r}_{N}\end{matrix} ] , U = [ \begin{matrix}{u}_{0} \\ {u}_{1} \\ ⋮ \\ {u}_{N - 1}\end{matrix} ] , D = [ \begin{matrix}{d}_{0} \\ {d}_{1} \\ ⋮ \\ {d}_{N - 1}\end{matrix} ] \qquad ( 4 )$$

and the predictions by the Equation (2) are expressed as

Z=φx₀+ΓU+Γ_{d}D (5)

Then φ, Γ and Γ_{d} are

$$\begin{matrix}φ = [ \begin{matrix}{C}_{z} A \\ {C}_{z} {A}^{2} \\ {C}_{z} {A}^{3} \\ ⋮ \\ {C}_{z} {A}^{N}\end{matrix} ] , Γ = [ \begin{matrix}{H}_{1} & 0 & 0 & … & 0 \\ {H}_{2} & {H}_{1} & 0 & … & 0 \\ {H}_{3} & {H}_{2} & {H}_{1} & & 0 \\ ⋮ & ⋮ & ⋮ & & ⋮ \\ {H}_{N} & {H}_{N - 1} & {H}_{N - 2} & … & {H}_{1}\end{matrix} ] , \\ and & ( 6 ) \\ {Γ}_{d} = [ \begin{matrix}{H}_{1 , d} & 0 & 0 & … & 0 \\ {H}_{2 , d} & {H}_{1 , d} & 0 & … & 0 \\ {H}_{3 , d} & {H}_{2 , d} & {H}_{1 , d} & & 0 \\ ⋮ & ⋮ & ⋮ & & ⋮ \\ {H}_{N , d} & {H}_{N - 1 , d} & {H}_{N - 2 , d} & … & {H}_{1 , d}\end{matrix} ] & ( 7 )\end{matrix}$$

For the case N=6, the matrices are

$$\begin{matrix}Λ = [ \begin{matrix}- I & I & 0 & 0 & 0 \\ 0 & - I & I & 0 & 0 \\ 0 & 0 & - I & I & 0 \\ 0 & 0 & 0 & - I & I\end{matrix} ] , & ( 8 ) \\ {Q}_{z} = [ \begin{matrix}{Q}_{z} & 0 & 0 & 0 \\ {Q}_{z} & {Q}_{z} & 0 & 0 \\ 0 & 0 & ⋱ & 0 \\ 0 & 0 & 0 & {Q}_{z}\end{matrix} ] , & ( 9 ) \\ {H}_{S} = [ \begin{matrix}2 S & - S & 0 & 0 & 0 \\ - S & 2 S & - S & 0 & 0 \\ 0 & - S & 2 S & - S & 0 \\ 0 & 0 & - S & 2 S & - S \\ 0 & 0 & 0 & - S & 2 S\end{matrix} ] \\ and & ( 10 ) \\ {M}_{{u}_{- 1}} = - [ \begin{matrix}S \\ 0 \\ 0 \\ 0 \\ 0\end{matrix} ] . & ( 11 )\end{matrix}$$

Q_{z} are tuned so that fuel bed height has more importance than drum pressure. S for primary air and stoker speed can be tuned separately from each other. Then the objective function is expressed as

$$\begin{matrix}φ = \frac{1}{2} {\sum }_{k = 1}^{N} {‖ {z}_{k} - {r}_{k} ‖}_{{Q}_{z}}^{2} + \frac{1}{2} {‖ Δ {u}_{k} ‖}_{S}^{2} \\ = \frac{1}{2} {U}^{′} HU + {g}^{′} U + ρ\end{matrix} \qquad ( 12 )$$

where

H=Γ′Q_{z}Γ+H_{S} (13)

g=Γ′Q_{z}φx₀−Γ′Q_{z}R+Mᵤ_{_{−1}}u₋₁+Γ′Q_{z}ΓₛD (14)

The MPC optimization problem of Equation (3) can be solved as a solution of the following convex quadratic program

$$min ψ = \frac{1}{2} {U}^{′} HU + {g}^{′} U \\ {U}_{min}^{U} \leq U \leq {U}_{max} \\ Δ {U}_{min} \leq Δ U \leq Δ {U}_{max} \\ {\overline{Z}}_{min} \leq Γ U \leq {\overline{Z}}_{max} \qquad ( 15 )$$

where

Z̅ₘᵢₙ=Zₘᵢₙ−φx₀−Γ_{d}D (16)

Z̅ₘₐₓ=Zₘₐₓ−φx₀−Γ_{d}D (17)

In order to achieve offset-free performance, the system of Equation (1) is augmented with integrating disturbance matrices [15]. The designed system uses an input disturbance model where B_{d}=B, A_{d} has only ones in diagonal, and C_{d} has only zeros.

$$\begin{matrix}[ \begin{matrix}{x}_{k + 1} \\ {η}_{k + 1}\end{matrix} ] = [ \begin{matrix}A & {B}_{d} \\ 0 & {A}_{d}\end{matrix} ] [ \begin{matrix}{x}_{k} \\ {η}_{k}\end{matrix} ] + [ \begin{matrix}B \\ 0\end{matrix} ] {u}_{k} + [ \begin{matrix}E \\ 0\end{matrix} ] {d}_{k} + [ \begin{matrix}{ω}_{k} \\ {ξ}_{k}\end{matrix} ] & ( 18 ) \\ {y}_{k} = [ C {C}_{η} ] [ \begin{matrix}{x}_{k} \\ {η}_{k}\end{matrix} ] + {υ}_{k} & ( 19 )\end{matrix}$$

The ωₖ and υₖ are white noise disturbances with zero mean. Thus, the disturbances and the states of the system are estimated as follows:

$$[ \begin{matrix}{\hat{x}}_{k \vert k} \\ {\hat{η}}_{k \vert k}\end{matrix} ] + [ \begin{matrix}{\hat{x}}_{k + 1 \vert k} \\ {\hat{η}}_{k + 1 \vert k}\end{matrix} ] + [ \begin{matrix}{L}_{x} \\ {L}_{η}\end{matrix} ] ( {y}_{k} - C {\hat{x}}_{kk - 1} - {C}_{η} {\hat{η}}_{k \vert k - 1} ) \qquad ( 20 )$$

and the state predictions of the augmented system of Equation (18) are obtained by

$$[ \begin{matrix}{\hat{x}}_{k + 1 \vert k} \\ {\hat{η}}_{k + 1 \vert k}\end{matrix} ] = [ \begin{matrix}A & {B}_{d} \\ 0 & {A}_{d}\end{matrix} ] [ \begin{matrix}{x}_{k \vert k} \\ {η}_{k \vert k}\end{matrix} ] + [ \begin{matrix}B \\ 0\end{matrix} ] {u}_{k} + [ \begin{matrix}E \\ 0\end{matrix} ] {d}_{k} \qquad ( 21 )$$

### Modeling of BioGrate Combustion

An unknown fuel moisture content and flue flow variations result in uncertainty in a combustion power. Therefore, the models for the water evaporation and for the fuel bed height are developed for BioGrate combustion.

### The Model of Water Evaporation

The model of water evaporation is [1]

$$\frac{d {m}_{w} ( t )}{d t} = - {c}_{wev} {m}_{w} ( t ) {α}_{wev} ( t ) + \frac{d {m}_{w , in} ( t - {T}_{d} ( t ) )}{d t} [ kg \text{/} s ] \qquad ( 22 )$$

where c_{wev} is the correction coefficient, α_{wev} is the coefficient for a dependence on the position of the moving grate, and m_{wev,in} the moisture in the fuel feed (kg/s).

$${T}_{d} ( t ) = {c}_{d} \frac{{m}_{w} ( t )}{{α}_{ds , in} {m}_{ds , in} ( t )} [ s ] \qquad ( 23 )$$

where c_{d} is the delay coefficient, α_{ds,in} is the stoker speed correction coefficient (kg/s/%), and m_{ds,in}(t) is the stoker speed (%).

$${m}_{w , in} ( t ) = {\int }_{0}^{t} {\dot{m}}_{w , in} ( τ ) d τ [ kg ] \qquad ( 24 )$$

### The Fuel Bed Height Model

In co-current combustion, devolatilization and char combustion take place in different regions, as shown in FIG. 6. First, the primary air enters the heat source. Then, the heat is transferred inside the bed. Next, the gas leaves the char combustion region and devolatilizes the fuel. Finally, the gas leaves the devolatilization zone and dries the fuel. In a steady state, combustion, drying, devolatilization, and char zones are separated from each other [10]. It is therefore correct to use only one zone for modelling the thermal decomposition of the fuel. Thus, the amount of dry biomass m_{ds} in the thermal decomposition zone is

$$\begin{matrix}\frac{d {m}_{ds} ( t )}{d t} = - {\dot{m}}_{thd} ( t ) + \frac{d {α}_{ds , in} {m}_{ds , in} ( t - {T}_{d} ( t ) )}{d t} & ( 25 ) \\ {m}_{ds , in} ( t ) = {\int }_{0}^{t} {\dot{m}}_{ds , in} ( τ ) d τ [ kg \text{/} s ] & ( 26 )\end{matrix}$$

where \dot{m}_{thd}(t) is the thermal decomposition rate of the fuel (kg/s). In [1], the effect of the primary air flow rate on the thermal decomposition of the fuel is multiplicative. However, in contrast to the model presented in [1], the following model for the thermal decomposition rate \dot{m}_{thd}(t) is proposed:

\dot{m}_{thd}=c_{thd}·\dot{m}ₚₐ−c_{ds}·m_{ds} [kg/s] (27)

where c_{thd} is the thermal decomposition rate coefficient, and c_{ds} the fuel bed height coefficient. The fuel bed height coefficient c_{ds} describes how a large bed height decreases the thermal decomposition rate of the fuel. Moreover, with a constant fuel bed height, the thermal decomposition increases linearly as the primary air flow rate increases.

### Fuel Flow Soft-Sensor

Oxygen consumption is a good measure of heat generation in a furnace of a power plant [12]. The amount of oxygen needed to completely burn one kilogram of the known fuel is

N_{O}_{₂}^{g}=n_{C}+0.5·n_{H}_{₂}+n_{S}−n_{O}_{₂} [mol/kg] (28)

The theoretical flue gas flow is thus

N_{fg}=n_{C}+n_{H}_{₂}+n_{S}+3.76·N_{O}_{₂}^{g}+n_{N}_{₂}+n_{H}_{₂}_{O} [mol/kg] (29)

where the value 3.76·N_{O}_{₂}^{g} is the nitrogen that comes with the combustion air. The thermal decomposition rate of the fuel is calculated as follows

$${\dot{m}}_{thd} ( w ) = \frac{( 0.21 - \frac{{X}_{{O}_{2}}}{100} ) {n}_{Air}}{{N}_{{O}_{2}}^{g} + \frac{{X}_{{O}_{2}}}{100} ( {N}_{fg} - 4.76 \cdot {N}_{{O}_{2}}^{g} )} [ kg \text{/} s ] \qquad ( 30 )$$

where X_{O}_{₂}(t+τ) is the flue gas oxygen content (%), and n_{Air} the sum of the primary and secondary air flows (mol/s). The flue gas flow \dot{m}_{fg} is calculated by multiplying moles of each component of Equation (29) with the molar masses of the component and then multiplying the result with the thermal decomposition rate of the fuel of Equation (30). The flue gas temperature in the furnace for the thermal decomposition rate of the fuel of Equation (29) is

$${T}_{fg} = ( {q}_{gf} + 0.2 ( {F}_{Air} / 22.41 \cdot {10}^{- 3} \cdot {\dot{m}}_{thd} ) {C}_{{O}_{2}} + 0.79 ( {F}_{Air} / 22.41 \cdot {10}^{- 3} \cdot {\dot{m}}_{thd} ) {C}_{{N}_{2}} ) / ( {n}_{C} {C}_{{CO}_{2}} + {n}_{S} {C}_{{SO}_{2}} + ( {n}_{{H}_{2} O} + {n}_{{H}_{2}} ) {C}_{{H}_{2} O} [ ° C . ] + ( 3.76 \cdot {N}_{{O}_{2}}^{g} + {n}_{{N}_{2}} ) {C}_{{N}_{2}} + 0.21 \cdot {N}_{ExAir} {C}_{{O}_{2}} + 0.79 \cdot {N}_{ExAir} {C}_{{N}_{2}} ) \qquad ( 31 )$$

where F_{Air} is the sum of the primary and secondary air flows (m³/s), Cᵢ the specific heat capacity i (J/molT), and the N_{ExAir} excess air (mol/kg).

### Fuel Moisture Soft-Sensor

The fuel moisture soft-sensor assumes that a change in the water evaporation rate affects the enthalpy of the secondary superheater; the effective value of the fuel q_{gf} changes linearly when the water evaporation rate changes [16]. The water evaporation rate w is obtained by minimizing

$$min J ( w ) = {\sum }_{i = 0}^{N} {\vert {h}_{2} - {\hat{h}}_{2} \vert}^{2} \qquad ( 32 )$$

where N is the prediction horizon, h₂ is the measured output enthalpy of the secondary superheater (MJ/kg), and ĥ₂ is the estimated output enthalpy of the secondary superheater (MJ/kg). The prediction model for the enthalpy of the secondary superheater is

$$\frac{d {h}_{2}}{d t} = \frac{1}{ρ V} ( {Q}_{t} + {\dot{m}}_{1} {h}_{1} - {\dot{m}}_{2} {h}_{2} ) [ MJ \text{/} ( s kg ) ] \qquad ( 33 )$$

where ρ is the specific density of the steam of the secondary superheater (kg/m³), V is the volume of the secondary superheater (m³), m₁ is the steam flow before the secondary superheater (kg/s), h₁ is the specific enthalpy before the secondary superheater (MJ/kg), and m₂ is the steam flow after the secondary superheater (kg/s). The heat transfer from the flue gas to the metal tubes of the secondary superheater in the presence of mixed convection and radiation heat transfer is

Q_{w}=α_{w}\dot{m}_{fg}^{0.65}((T_{fg}−α_{fo}·T_{fo})−T_{w})+k_{w}((T_{fg}−α_{fo}·T_{fo})⁴−T_{w}⁴) (34)

where α_{w} is the convection heat transfer, α_{fo} is the correction coefficient, T_{fo} is the flue gas temperature after the economizer (° C.), T_{w} is the temperature of the metal tubes of the secondary superheater (° C.), and k_{w} is the radiation heat transfer coefficient. The temperature for the tube walls of the secondary superheater is

$$\frac{d {T}_{w}}{d t} = \frac{1}{{m}_{t} {C}_{p}} ( {Q}_{w} - {Q}_{t} ) [ K \text{/} s ] \qquad ( 35 )$$

where mₜ is the mass of the metal tubes of the secondary superheater (kg), and Cₚ is the specific heat of the metal (MJ/kgK). The heat transfer from the metal tubes of the secondary superheater to the steam in the presence of convection heat transfer is

Qₜ=α_{c}m₂^{0.8}(T_{w}−T) [MJ/s] (36)

where α_{c} is the convection heat transfer coefficient.

T=(T₁+T₂)/2[° C.] (37)

where T₁ is the steam temperature before the secondary superheater (° C.) and T₂ the steam temperature after the secondary superheater (° C.).
the secondary superheater (° C.).

### Test Results

### System Identification of the Dry Fuel Content's Model

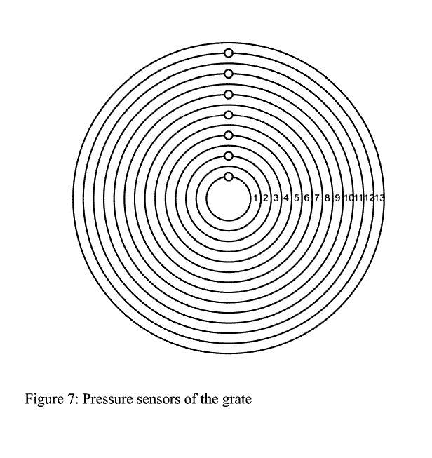

The system identification of the models of the fuel bed height and the thermal decomposition of the dry fuel was conducted using the measurements of the BioPower 5 CHP plant. The aim of the system identification was to determine the coefficients c_{ds} and c_{thd}. The fuels used were spruce bark with a moisture content of 54% and composition (51.5% carbon, 6.2% hydrogen, less than 0.3% nitrogen, 0.2% sulfur, and 2.8% ash) and dry spruce woodchips with a moisture content of 20% and composition (51.0% carbon, 6.0% hydrogen, less than 0.2% nitrogen, less than 0.2% sulfur, and 0.5% ash). The both fuels had a same dry fuel effective heat capacity of 18.9 MJ/kg. In addition, 8 pressure sensors have been installed in the rings 1-8, as illustrated in FIG. 7, to measure the fuel bed height pressure. The samples were recorded in 1 second interval. The thermal decomposition of the dry fuel was calculated according to Equation (30).

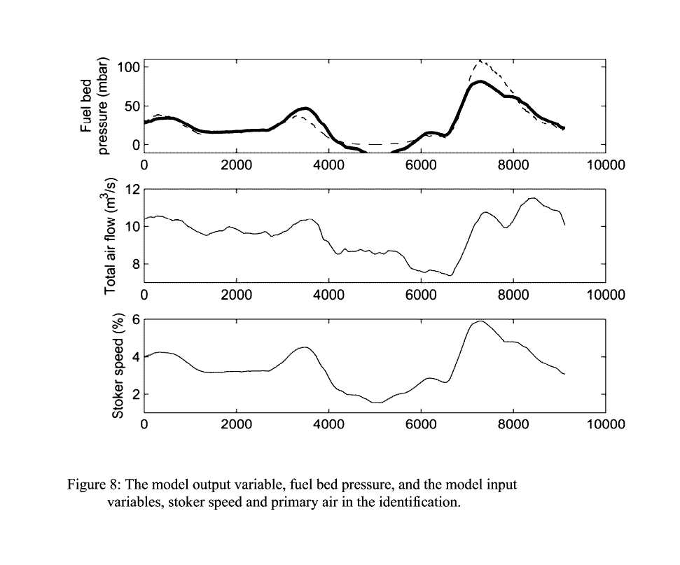

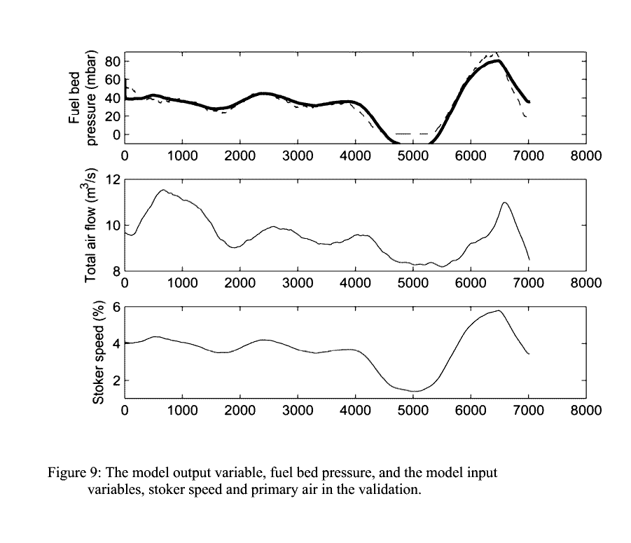

FIG. 8 shows the estimated and measured fuel bed height pressure and the inputs, total air flow, and stoker speed based on the measurements. The performance of the fuel bed height model is shown in FIG. 9.

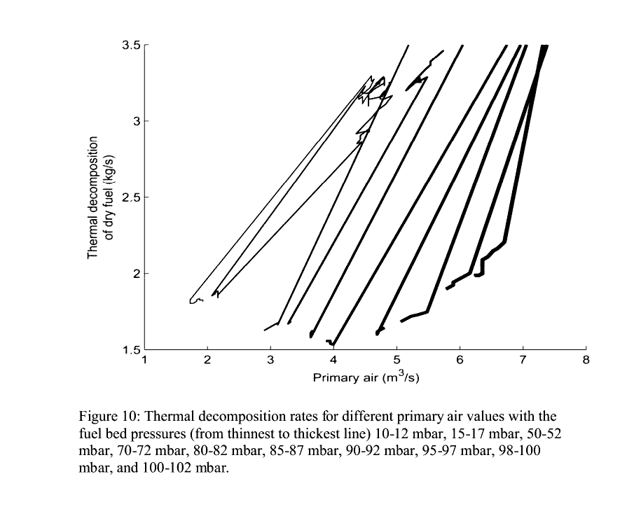

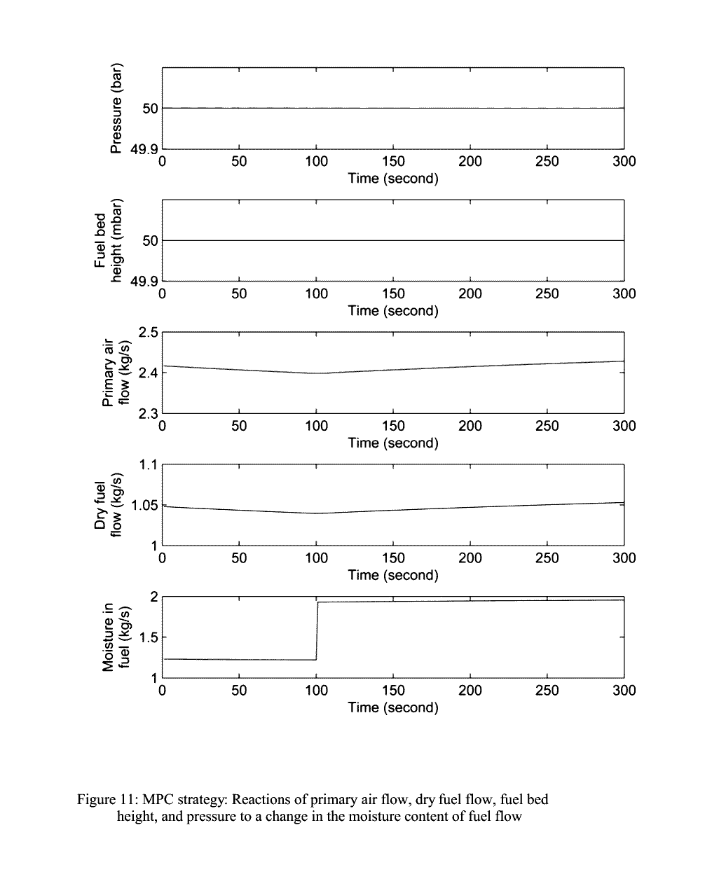

The thermal decomposition rate for different primary air flow rates and different fuel bed heights are shown in FIG. 10. The results show that an increase in fuel bed height requires an increase in primary air flow to maintain the same thermal decomposition rate. In addition, the amount of primary air needed grow almost linearly.

### Test Results of the MPC Strategy for BioGrate Boiler

The MPC strategy was compared with the currently used control strategy in a MATLAB programming environment. In the first simulation test, the moisture content in the fuel feed was changed from 54% to 65% while the steam demand was 14 MW.

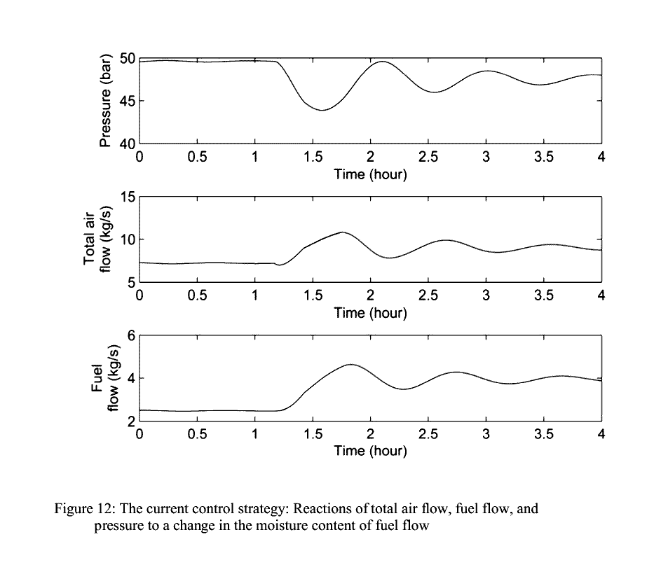

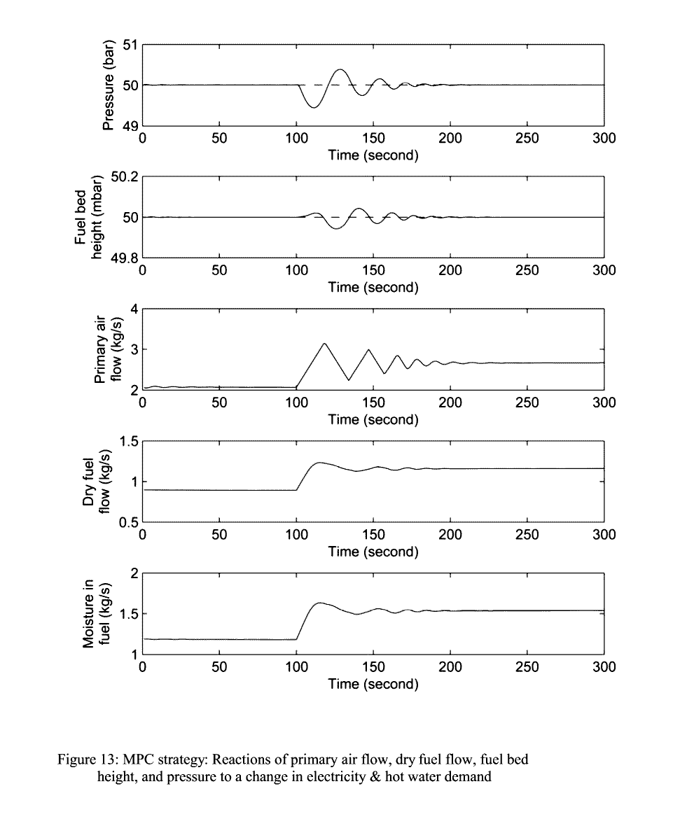

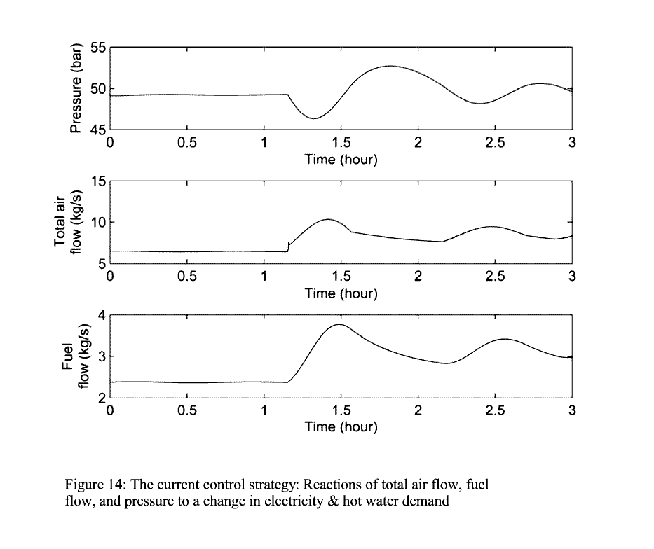

In the second simulation test, the steam demand was changed from 12 MW to 16 MW while the moisture content in the fuel feed was 57%. The reason for the fast settling time of 2 minutes in the response of the developed MPC strategy is that fuel bed is used as a buffer instead of directly connecting primary air flow rate to the stoker speed (FIGS. 11-14). This fast response is then achieved by manipulating the primary air flow rate while keeping the fuel bed height at a desired level. In comparison, the settling time in the response of the currently used control strategy is 2 h.

### Conclusions

A model predictive control (MPC) strategy for efficient energy production in a BioGrate boiler has been presented as an example. In addition to compensating for the main disturbances caused by variations in fuel quality—such as fuel moisture content and fuel flow—the strategy modeled and monitored the fuel bed height of the grate.

The system identification of the models of the fuel bed height and the thermal decomposition of the dry fuel was conducted using the measurements of the BioPower 5 CHP plant. The results clearly show that an increase in fuel bed height requires an increase in primary air flow to maintain the same thermal decomposition rate.

The MPC strategy for the BioGrate boiler was tested in a controlled simulation environment. The fast settling time in the response of the developed MPC strategy was achieved by regulating the primary air while keeping the fuel bed height at a desired level. In comparison, the settling time in the response of the currently used control strategy was 2 h.

One preferable contribution of the invention is the development of the fuel moisture soft-sensor, its combination with the combustion power method, and utilizing the methods in the control strategy improvement of the BioGrate boiler. Additionally, the novel fault tolerant model predictive control of the BioPower 5 CHP process has been developed to compensate the variations in the fuel quality and to tolerate the faults in the fuel bed height sensor. A notable feature is incorporating the fuel moisture soft-sensor and the combustion power estimation into the fault tolerant MPC framework.

In the following the embodiments of the invention are described more closely. Numbering of the equations concerns the following text only.

### Description of the BioGrate Process and its Control Strategy

The BioPower 5 CHP process consists of two main parts: the furnace and the steam-water circuit. The heat used for steam generation is obtained by burning solid biomass fuel—consisting of bark, sawdust, and pellets—which is fed into the furnace together with combustion air. The heat of the flue gas is transferred by the heat exchangers to the steam-water circulation, where superheated steam is generated (Kallioniemi, 2008).

In the BioGrate system (Anon, 2014), the fuel is fed onto the center of a grate from below through a stoker screw. The grate consists of alternate rotating and stationary concentric rings with the rotating rings alternately rotated clockwise and counter-clockwise by hydraulics. This design distributes the fuel evenly over the entire grate, with the burning fuel forming an even layer of the required thickness.

The moisture content of the wet fuel in the centre of the grate evaporates rapidly due to the heat of the surrounding burning fuel and the thermal radiation coming from the brick walls. The gasification and visible combustion of the gases and solid carbon takes place as the fuel moves to the periphery of the circular grate. At the edge of the grate, ash finally falls into a water-filled ash basin underneath the grate.

The primary air for combustion and the recirculation flue gas are fed from underneath the grate and they penetrate the fuel through the slots in the concentric rings. The secondary air is fed directly into the flame above the grate and the air distribution is controlled by dampers and speed-controlled fans. The gases released from biomass conversion on the grate and a small number of entrained fuel particles continue to combust in the freeboard, in which the secondary air supply plays a significant role in the mixing, burnout, and the formation of emissions. The design of the air supply system, the ratio between primary and secondary air, plays a key role in the efficient and complete combustion of biomass (Yin et al., 2008). In modern grate-fired boilers burning biomass, the split ratio of primary to secondary air is 40/60, which should be followed by a control design for the most efficient energy production. The overall excess air for most biomass fuels is normally set at 25% or above.

The essential components of the water-steam circuit are an economizer, a drum, an evaporator, and superheaters, as shown in FIG. 3. Feed water is pumped from a feed water tank into the boiler. First the water is led into the economizer (4), which is the last heat exchanger extracting the energy from the flue gas, and thus, improving the efficiency of the boiler. From the economizer, the heated feed water is transferred into the drum (5) and along downcomers into the bottom of the evaporator (6) through tubes that surround the boiler. From the evaporator tubes, the heated water and steam return back into the steam drum, where they are separated. The steam rises to the top of the steam drum and flows into the superheaters (7) where it heats up further and superheats. The superheated high-pressure steam (8) is then passed into the steam turbine, where electricity is generated.

### Control Strategy of the BioGrate Process

The main objective of the biopower plant is to produce the desired amount of power for the generator and for the hot water network. The difference between the consumed and produced power disturbs the pressure in the drum, and the control strategy equalize the steam production and consumption by controlling the drum pressure, which is achieved by manipulating the fuel and air supply to the furnace. Two feedforward and one ratio controllers attenuate variations during the transitions in the power demand.

In more details, the drum pressure control and the feedforward control, designed to compensate the variations of the superheated steam flow, determine the primary air flow setpoint. Based on the primary air flow, the ratio control computes the target level of the stoker speed to maintain the fuel feed according to the current combustion power level. The primary air defines the intensity of the pyrolysis and combustion, and the amount of the excess air (the secondary air) should follow the primary air to achieve the complete combustion. Thus, the feedforward controller is used to vary the secondary air proportionally to the primary air flow. However, the change in the fuel moisture content and the disturbances in the fuel feed are not taken into account in the control strategy, therefore causing oscillation in steam pressure.

### Modeling and Control of Grate Boilers; Present

The following text presents practices used currently in modeling and control of grate boilers. In more details, the mechanistic modeling of grate boilers is briefly presented, the techniques for measuring the fuel moisture content are reviewed, and a survey on the control methods of grate boilers is presented.

### Modeling of the Grate Combustion of Biomass

As the basis for the modeling work, the effect of fuel properties on the combustion has been actively studied. Saastamoinen et al. (2000) studied the effects of the air flow rate, fuel moisture content, particle size, bed density, and wood type. Moisture did not have any noticeable effect on the maximum temperature in the bed when the moisture was less than 30 wt %. The velocity of the combustion front was found to be inversely proportional to the density of the fuel and specific heat of wood. Yang et al. (2003) conducted detailed mathematical simulations as well as experiments on the combustion of wood chips, and the incineration of simulated municipal solid wastes in a stationary bed. They concluded that the ignition time is influenced by both the devolatilization rate and the moisture content of the fuel. Furthermore, an increase in the fuel moisture shifts the combustion stoichiometry to a fuel-lean condition.

Similarly, Yang et al. (2005a) employed the mathematical model of a packed bed system to simulate the effects of the particle size, material density, bed porosity and the fuel calorific value on the combustion characteristics in terms of combustion rate, combustion stoichiometry, flue gas composition, and solid-phase temperature. They demonstrated that the combustion rate is determined by both the fuel particle size and the fuel density: smaller fuel particle sizes resulted in higher combustion rates due to the increased heat and mass transfer area and enhanced gas-phase mixing in the bed. The combustion front propagation velocity decreases as the biomass material density increases. Yang et al. (2005b) further investigated the effect of particle size on pinewood combustion in a packed bed and they concluded that both char burnout and fuel devolatilization occur at the same time in a bed of large particles.

As a conclusion from the previous studies, the particle size was found to have a strong effect on the combustion process. Johansson et al. (2007) investigated the use of a porous media approximation in the modeling of the fixed bed combustion of wood and concluded that the model is acceptable for the particle size below 2 cm. For modeling purposes, the combustion ongoing in separate particles has to be considered in more details when the particle size is large. Recently, Ström & Thunman (2013) presented a robust and computationally efficient particle submodel for use in computational fluid dynamics (CFD) simulations. Gómez et al. (2014) presented a bed compaction submodel to account for the local shrinkage of the bed fuel during the combustion.

The co-current combustion conditions were compared with the counter-current conditions by Thunman & Leckner (2001). In the case of the co-current combustion, the ignition of biofuel starts at the surface of the grate, and the heat generated at the bottom of the bed by char combustion is transferred along with the gas up through the bed. In the result, the air flow dries and devolatilizes fresh fuel, and combustion is possible with a moisture content of up to 70 or 80%. In the case of the counter-current conditions, when the fuel is ignited from the top, such moisture content would be excessively high, since devolatilization and combustion occur in a narrow front. Further comparison of the co-current and counter-current fixed bed combustion of biofuel was given in (Thunman & Leckner, 2003). The results show that at steady co-current combustion, drying, devolatilization, and char combustion occur separately, whereas the three stages occur in a close proximity to each other during the entire counter-current combustion process.

Based on these findings, Bauer et al. (2010) derived a simplified furnace model suitable for control and optimization purposes. The simplified model is based on two separate mass balances for water and dry fuel in the bed. It was assumed in the model that the overall effect of the primary air flow rate on the thermal decomposition of dry fuel is proportional, as confirmed by many authors (van der Lans et al., 2000; Johansson et al., 2007; Blasi, 2000). The results obtained by Boriouchkine et al. (2014) also demonstrated that combustion dynamics is strongly dependent on the air flow. In addition, Bauer et al. (2010) assumed in their model that the water evaporation rate is mainly independent of the primary air flow, which was confirmed by the conducted experiments. The proposed model was verified by experiments at a pilot scale furnace with a horizontally moving grate.

### Methods for Determination of the Moisture Content in Biomass

The moisture content of the fuel has to be determined with a delay within seconds to allow the control system to correctly adjust the combustion air supply and the fuel feed. However, the typical procedure, the manual analysis of the collected samples from each fuel batch delivered to the plant, is not accurate enough to predict the moisture content of the fuel entering the furnace. As an alternative, the fuel moisture content can be determined on-line by direct measurements or using indirect methods. The direct measurements include the use of dual-energy X-ray absorptiometry (DXA) (Nordell & Vikterlöf, 2000), near infrared spectroscopy (NIR) (Axrup et al., 2000), radio frequency (RF), microwave (Okamura & Zhang, 2000), and nuclear magnetic resonance (NMR) (Rosenberg et al., 2001) (Nyström & Dahlquist, 2004). Among these methods, NIR has been investigated the most as a promising method to analyze the fuel moisture content either by an automatic sampling on the delivery or in the fuel mix before it is injected into the furnace. However, these methods are not economically feasible for small-scale combustors as they demand measurement a set-up and calibration.

The fuel moisture content can be derived indirectly from the water mass balance in the furnace, involving the measurement of the flue gas moisture content, the composition of the combustion air and the elementary composition of the dry fuel. The only delay of the measurement signal in this setup is due to the transport time of the gas from the furnace to the measurement position. As a result, the fuel moisture can be estimated within seconds, which opens up the possibility for successful disturbance compensation by the plant control. The flue gas moisture content required by the method can be measured directly using, for example, the fourier-transform infrared (FT-IR) technology (Jaakkola et al., 1998) or calculated from the relative humidity (RH) of the flue gas (Hermansson et al., 2011). Bak & Clausen (2002) have developed and interfaced a fibre-optic probe for an FT-IR instrument for simultaneous and rapid measurements of gas temperature and composition. The combined error in the gas temperature was equal to 3.5° C. (63% confidence level) which is critical to identify gas components. Jaakkola et al. (1998) investigated the feasibility of a transportable FT-IR gas analyzer for analyzing wet extractive stack gas and they reported a relative standard deviation of 4.1% for moisture content. However, FT-IR-based analysis has been reported to be sensitive to the absolute temperature, pressure, temperature gradients, and particles carried within the gas, complicating measurements carried out directly in the flue gas duct and weakening the usability of the method.

Another method for measuring the flue gas moisture content, using a relative-humidity (RH) sensor, was developed by Hermansson et al. (2011) with the aim of improving the accuracy level of indirect determination of moisture content of fuel in a biomass furnace. The method was tested on a laboratory scale multi-fuel CFB boiler, burning wood chips of approximately 42 w-% moisture content, and a grate furnace, burning saw dust of approximately 54 w-% moisture content. Accurate results were achieved by a prior cooling of the extracted flue gas stream to approximately 80° C., which increased the RH of the flue gases. The results of the tests showed that the method predicts the moisture content of the biomass fuel in the furnace with a good precision (<4% error) after a calibration and that the method was able to detect variations in moisture content within seconds. However, in order to use this method, additional devices, measurements, and calibration are needed. In conclusion, both FT-IR and RH methods are too complicated and expensive to be used in a small-scale biograte process.

### Combustion Power and Fuel Moisture Soft-Sensors

The original method of Kortela & Lautala (1982) assumed a constant fuel moisture content, even though the relative ratio of oxygen in the flue gas is affected by the variations of the fuel moisture contents, which introduces an error to the estimation. Recently, the combustion power method was improved by Kortela & Jämssä-Jounela (2010) who estimated the fuel moisture content from the steady-state energy balance of the boiler involving the combustion power estimation. As a result, the oxygen mass balance calculations were corrected and the error of the combustion power estimation was removed. Furthermore, as the combustion power is computed from the thermal decomposition rate, the consideration of the fuel moisture content improves the accuracy of the calculations.

The method of Kortela & Jämsä-Jounela (2010) considered the heat-exchange in the whole steam-water circuit of the boiler. In j1, the combustion power and fuel moisture estimation methods were further improved by developing and employing a nonlinear superheater model. The internal energy and the moisture content of the flue gas have been considered to estimate the power of the heat transfer in the superheater, which greatly reduced the delay of the fuel moisture estimation. The method was tested by the industrial tests.

### Control of a Grate Boiler

The combustion power method developed by Kortela & Lautala (1982) was employed by many control strategies to compensate variations in the fuel quality. Based on the combustion power method, in the same publication Kortela & Lautala (1982) suggested a feed-forward control: adjusting the fuel feed flow according to the thermal decomposition rate to stabilize the amount of the fuel in the furnace. As a result, the effect of the feed disturbance on the generated steam pressure decreased to about one third of the original value, and the settling time decreased from 45 min to only 13 min. The same method has later been applied to a grate boiler (Kortela & Marttinen, 1985).

Lehtomäki et al. (1982) implemented the combustion power based control in a peat power plant. The effective heat value of peat varies from 1200 to 4600 MJ/m³ due to the moisture, density, and the age of peat. Moreover, the volume feeders were used in the process, which caused uncertainty in the mass flow rate of the fuel. By introducing the combustion power based compensation to the process control, Lehtomäki et al. (1982) reduced the standard deviation of the flue gas oxygen content to as low as ±0.1%, which it made possible to lower the total air flow and to reduce the flue gas energy losses. Furthermore, the stabilized steam temperature reduced the thermal stress on superheaters and connected pipes.

As an alternative method to stabilize the furnace state, Paces et al. (2011) presented a method to decouple the control of the boiler load and the amount and the distribution of fuel on the grate. Compared with the combustion power approach, the proposed method required an additional measurement for the fuel bed height profile, which can be estimated from the pressure drop over the grate, gas concentrations, the temperature and/or radiation in the furnace. The simulation results have confirmed the ability of the proposed control method to smoothly perform the transitions during the power load changes.

Recently, the model predictive control has proven to be a successful method for controlling renewable fuel power plants. In particular, the benefits of MPC-based control over conventional multivariable control have been demonstrated by Leskens et al. (2005) at a grate boiler combusting municipal solid waste. Gölles et al. (2011, 2014) implemented and experimentally verified a model based control in a commercially available small-scale biomass boiler using the simplified first-principle model that has been discussed. In more details, the mass of water in the water evaporation zone and the mass of dry fuel in the thermal decomposition zone on the grate are considered as the states of the simplified model and are estimated by an extended Kalman filter. Test results showed that the control was always able to provide the required power whereas the conventional control (PID control based on standard control strategies) could not tolerate a feed water temperature drop of more than 7° C. In addition, the control was able to operate the plant with a lower excess oxygen content during the load drop and especially under partial load conditions. The better control of the residual oxygen and the control of the air ratio led to lower emissions and higher efficiencies. In addition, the model-based control was able to handle without difficulties a step-wise change in the fuel moisture content from 26% to 38% and vice versa.

Kortela and Jämsä-Jounela have presented a control based on the combustion power and fuel moisture content soft-sensors. This control was extended in by employing the fuel bed height measurements, as it was originally suggested by Paces et al. (2011).

### Fault Tolerant Model Predictive Control (FTMPC) for the BioGrate Boiler

In the following, the development of FTMPC and its modules for the BioGrate boiler are presented. First, the FTMPC is introduced, second, the overall FTMPC strategy is described. Methods to estimate the thermal decomposition of the dry fuel, and a soft-sensor to estimate the water evaporation in the furnace are outlined. The dynamic models of the BioGrate boiler are detailed and the detection of faults in the fuel bed height sensor is presented. Finally, the MPC of the BioGrate boiler is presented including the controller reconfiguration.

### Introduction to FTMPC

During the last decades, the applications of fault detection and isolation (FDI), as well as model predictive control (MPC), have been among the most active research areas in the field of control, especially, in process industries. In particular, the diagnosis of equipment malfunctions and process faults is considered to be one of the most important actions in the process supervision (Frank et al., 2000). In order to tolerate faults while maintaining desirable stability and performance properties, the fault-tolerant control schemes (FTCS) have been developed (Zhang & Jiang, 2008).

In specification, the active fault tolerant control approach is considered, in which the diagnosed fault triggers the corrective actions, including the fault accommodation and the controller reconfiguration, as demonstrated. The accommodation means that the FTCS uses the information provided by the FDI to obtain the compensated or corrected estimates of the state variables, measured values, and manipulated inputs, and appropriately modifies the inputs and/or outputs of the existing controller with no modifications in its internal working, as illustrated in FIG. In active FTCS, the reconfigured control parameters are frequently precomputed for all considered fault scenarios. In contrast, Zheng et al. (1997) used the theory of LMI to synthesize the control feedback as a function of “fault effect vectors”, which are derived from the residual vector of the FDI.

Several applications of FTC in the process industry have been developed in the last decade. An active FTC strategy for the Naantali refinery de-aromatization process was developed by Sourander et al. (2009) and extended by Kettunen & Jämsä-Jounela (2011). On the basis of the economic evaluation of just one feed grade, the annual estimated savings of the integrated FTMPC were predicted to be up to as much as USD 143 000.

In the active fault-tolerant control, fault detection plays a crucial role: without the proper detection of the faults, the corrective actions cannot be activated and the fault cannot be accommodated. Venkatasubramanian et al. (2003) divide faults into the following categories: structural changes in the process, actuator faults, sensor faults, gross parameter changes in the model, and external faults. Fault identification attempts to identify the fault type, the magnitude of the fault, and the direction of the fault in order to make it possible for the controller to counter the effect of the faults (Frank et al., 2000). The data based methods, including PCA (Li et al., 2000), PLS (Qin, 1998), and neural networks (Kohonen, 1990), as well as the model-based methods, such as parity equations (Haghani et al., 2014), observers and parameter estimation have been developed in the literature. For example, Prakash et al. (2002) implemented a fault detection and diagnosis method based on state estimation and integrated it to a FTCS. They showed that the FDD reformulated using the identified innovations form of state space model is able to isolate sensor faults as well as actuator faults. In addition, simulation studies of Patwardhan et al. (2006) showed that there is a need to deal with the abrupt changes in the unmeasured disturbances systematically in the FDI framework to improve its robustness.

### FTMPC for the BioGrate Boiler

The overall structure of the FTMPC follows the active FTC scheme, adjusting the plant control according to the fault diagnosis results. In more detail, two different MPC configurations have been developed for the cases of normal and faulty operations of the fuel bed height sensor. In the faultless mode, the MPC configuration is as follows: the primary air flow rate and the stoker speed are the manipulated variables (u); the moisture content in the fuel feed and the steam demand are the measured disturbances (d); and the fuel bed height and the steam pressure are the controlled variables (y). The fault is accommodated by employing an alternative estimation of the fuel bed height, which is based on the thermal decomposition rate. However, as the alternative estimation is less accurate, the control reconfiguration is also needed, shifting its focus to the combustion power control while the fuel height is given a low priority. Additionally, the fuel bed height is kept within the security limits in both configurations in order to avoid plant shutdowns.

The combustion power and fuel moisture soft-sensors are used to compensate the effect of the fuel quality variations. In particular, the fuel moisture estimation is considered by the MPC as a measured disturbance and is also used to estimate the amount of water in the furnace. Considering the combustion power as a model state enables rapid energy production level changes and improves the control performance during the transitions. In addition, the thermal decomposition rate is used in the calculations of the fuel bed height, which makes the fault detection and accommodation possible. According to the fault detection results, the decision on the control reconfiguration is made, which is then communicated to the fault accommodation and the FTMPC. Depending on the rₚ value, the fault accommodation employs either the fuel bed height measurement or the thermal decomposition rate and the primary air flow for the MPC state estimation. Also, FTMPC is switched between the normal and the faulty configurations according to the rₚ signal. The modules of the FTC are described in the following subsections in more details.

### Combustion Power and Fuel Moisture Soft-Sensors

This subsection presents the combustion power and fuel moisture soft sensors. The heat value of the fuel, involved in the energy balances utilized by the soft-sensor, is introduced first. The original combustion power method of (Kortela & Lautala, 1982), estimating the thermal decomposition rate based on the oxygen mass balance, is given in the second subsection. Next, the fuel moisture soft-sensor is presented, considering the energy balance for the superheater. Finally, a discussion on the synergy of the soft-sensors is provided, meaning the accuracy of both soft-sensors is improved by sharing information between them. The heat value of dry and wet biomass

The heat value of a fuel can be determined by using the equation that has been derived from the heat values of the combustible components of fuel when they react with oxygen (Effenberger, 2000). The effective heat value of a dry fuel is (higher heat value):

q_{wf}=0.348·w_{C}+0.938·w_{H}+0.105·w_{S}+0.063·w_{N}−0.108·w_{O} [MJ/kg] (1)

where w_{C} is the mass fraction of carbon in the fuel (%), w_{H} is the mass fraction of hydrogen in the fuel (%), w_{S} is the mass fraction of sulfur in the fuel (%), w_{N} is the mass fraction of nitrogen in the fuel (%), and w_{O} the mass fraction of oxygen in the fuel (%). The effective heat value of a wet fuel (lower heat value) is obtained using the following equation:

q_{qf}=q_{wf}·(1−w/100)−0.0244·w [MJ/kg] (2)

where 0.0244 is the heat of vaporization of water, and w the moisture content of the wet fuel (%). In order to use Equation 1, the composition of typical fuels is given in Table 1.

TABLE 1
The composition of typical wood fuels burned in the Biopower
5 CHP plant

| | |
|---|---|
| | Moisture |
| Dry content (%) | (%) |

| Fuel | w_{C} | w_{H} | w_{O} | w_{N} | Ash | w |
|---|---|---|---|---|---|---|
| Pine | 54.5 | 5.9 | 37.6 | 0.3 | 1.7 | 60 |
| Spruce | 50.6 | 5.9 | 40.2 | 0.5 | 2.8 | 60 |
| Wood mix | 50.4 | 6.2 | 42.5 | 0.5 | 0.4 | 50 |

### Thermal Decomposition of Fuel and Combustion Power Estimation

There are no direct online measurements available for the thermal decomposition of dry fuel. However, it can be estimated by utilizing combustion power soft-sensor. Oxygen consumption is a good measure of heat generation in such plants (Kortela & Lautala, 1982). As there is no direct measurement for the thermal decomposition of fuel, it is calculated indirectly by utilizing the flue gas oxygen content and the total air measurements.

TABLE 2
Moles of the components of the fuel per unit mass

| | Mass | | |
|---|---|---|---|
| | fraction | | |
| Comp. | (%) | Mᵢ(g/mol) | nᵢ (mol/kg) |
| C | w_{c}(1 − w/100) | 12.011 | w_{c}(1 − w/100)10/M_{C} |
| H | wₕ(1 − w/100) | 2.0158 | wₕ(1 − w/100)10/M_{H} |
| S | wₛ(1 − w/100) | 32.06 | wₛ(1 − w/100)10/M_{S} |
| O | wₒ(1 − w/100) | 31.9988 | wₒ(1 − w/100)10/M_{O} |
| N | wₙ(1 − w/100) | 28.01348 | wₙ(1 − w/100)10/M_{N} |
| Water | w | 18.0152 | 10/M_{W} |

The amount of oxygen needed for fuel combustion is determined from the reaction equations. Table 2 presents the moles of the fuel components per mass unit of the fuel. In summary, based on the amount of oxygen needed for a complete combustion of the different fuel components, minus the amount of oxygen in the fuel, the theoretical amount of oxygen needed to completely burn one kilogram of fuel is given by:

N_{O}_{₂}^{g}=n_{C}+0.5·n_{H}_{₂}+n_{S}−n_{O}_{₂} [mol/kg] (3)

Air consists mainly of oxygen and nitrogen (argon is often included in the nitrogen portion): 21 v-% oxygen and 79 v-% nitrogen. Theoretically, the corresponding amount of dry air needed is thus:

$${N}_{Air} = {N}_{{O}_{2}}^{g} \cdot \frac{1}{0.21} = {N}_{{O}_{2}}^{g} \cdot 4.76 [ mol \text{/} kg ] \qquad ( 4 )$$

Flue gases contain, in addition to combustion products, nitrogen N that comes with the combustion air. Flue gas calculations, therefore, include 3.76 times more nitrogen than the amount of oxygen necessary for complete combustion. Incombustible components, such as water, are included in the equations as such, meaning the flue gas flow for one kilogram of fuel is thus:

N_{fg}=n_{C}+n_{H}_{₂}+n_{S}+3.76·N_{O}_{₂}^{g}+n_{N}_{₂}+n_{H}_{₂}_{O} [mol/kg] (5)

Similarly, the flue gas losses per kilogram of fuel are determined by:

$${q}_{fg}^{g} = ( {n}_{C} {C}_{{CO}_{2}} + {n}_{S} {C}_{{SO}_{2}} + ( {n}_{{H}_{2} O} + {n}_{{H}_{2}} ) {C}_{{H}_{2} O} + ( 3.76 \cdot {N}_{{O}_{2}}^{g} + {n}_{{N}_{2}} ) {C}_{N} + ( {F}_{Air} / ( 22.41 \cdot {10}^{- 3} \cdot {\dot{m}}_{gf} ) [ J \text{/} kg ] - 4.76 \cdot {N}_{{O}_{2}}^{g} ) {C}_{Air} ) \cdot ( {T}_{fg} - {T}_{0} ) \qquad ( 6 )$$

where Cᵢ is the specific heat capacity of the component i (J/molT), F_{Air} is total air flow (m³/s), \dot{m}_{fg} is the thermal decomposition rate of the fuel (kg/s), T_{fg} is the temperature of the flue gas (° C.), and T₀ the reference temperature (° C.).

The combustion power of the BioGrate boiler is estimated using Equations 7-11.

The total oxygen consumption is

$${\dot{n}}_{{O}_{2}}^{tot} = 0.21 \cdot {\dot{n}}_{Air} - \frac{{X}_{{O}_{2}}}{100} \cdot {\dot{n}}_{fg} [ mol \text{/} s ] \qquad ( 7 )$$

where \dot{n}_{O}_{₂}^{tot} is total oxygen consumption (mol/s), \dot{n}_{Air} is total air flow (mol/s), X_{O}_{₂}(t) is the oxygen content of the flue gas (%), and \dot{n}_{fg} the flue gas flow (mol/s).

The flue gas flow is:

\dot{n}_{fg}=\dot{m}_{gf}·N_{fg}+\dot{n}_{Air}−4.76·\dot{m}_{gf}·N_{O}_{₂}^{g} [mol/s] (8)

On the other hand, the oxygen consumption can also be presented in the following form:

\dot{n}_{O}_{₂}^{tot}=\dot{m}_{gf}·N_{O}_{₂}^{g} [mol/s] (9)

and thus the thermal decomposition rate for the wet fuel is calculated as follows:

$${\dot{m}}_{gf} = \frac{( 0.21 - \frac{{X}_{{O}_{2}}}{100} ) {\dot{n}}_{Air}}{{N}_{{O}_{2}}^{g} + \frac{{X}_{{O}_{2}}}{100} ( {N}_{fg} - 4.76 \cdot {N}_{{O}_{2}}^{g} )} [ kg \text{/} s ] \qquad ( 10 )$$

For the dry fuel, the calculations are done similarly. The denominator of Equation 30 is the amount of oxygen theoretically needed to burn one kilogram of fuel completely, added to the oxygen content in the flue gas.

Finally, the net combustion power for a given fuel flow is:

Q=(q_{qf}−q_{fg}^{g}−q_{cr})·\dot{m}_{gf} (11)

where q_{cr} is convection and radiation losses (MJ/kg).

### Fuel Moisture Soft-Sensor

The developed fuel moisture soft-sensor estimates the water evaporation rate, from which the fuel moisture content can then be derived from the mass balance. The water evaporation affects the enthalpy of the secondary superheater, as the effective heat value of the fuel q_{qf} depends linearly on the fuel moisture content as shown by Equation 2. Therefore, by using the combustion power calculations presented in the previous section, by considering the heat transferred into the secondary superheater, the fuel moisture content w is obtained by minimizing:

$$min J ( w ) = {\sum }_{t = 0}^{{N}_{w}} {\vert {h}_{2 , i} - {\hat{h}}_{2 , i} \vert}^{2} \qquad ( 12 )$$

where N_{w} is the prediction horizon, h_{2,i} is the measured steam enthalpy after the secondary superheater (MJ/kg), and ĥ_{2,i} is the estimated steam enthalpy after the secondary superheater (MJ/kg). The model of the secondary superheater is defined as:

$$\frac{d {h}_{2}}{d t} = \frac{1}{ρ V} ( {Q}_{s} + {\dot{m}}_{1} {h}_{1} - {\dot{m}}_{2} {h}_{2} ) [ MJ \text{/} ( s \cdot kg ) ] \qquad ( 13 )$$

where h₂ is the specific output enthalpy of the steam/water (MJ/kg), ρ is the specific density of the steam/water (kg/m³), V is the volume of the steam/water (m³), \dot{m}₁ is the input steam/water flow (kg/s), h₁ is the specific input enthalpy of the steam/water (MJ/kg), and \dot{m}₂ is the output steam/water flow (kg/s).

The heat transfer from the flue gas to the metal walls in the presence of mixed convection and radiation heat transfer is (Lu, 1999; Lu & Hogg, 2000):

Q_{fg}=α_{fg}\dot{m}_{fg}^{0.65}((T_{fg}−c_{fo}·T_{fo})−Tₘₜ)+k_{fg}((T_{fg}−c_{fo}·T_{fo})⁴−Tₘₜ⁴) [MJ/s] (14)

where α_{fg} is the convection heat transfer coefficient, c_{fo} is the correction coefficient, T_{fo} is the outlet flue gas temperature (° C.), Tₘₜ is the temperature of the metal tubes (° C.), and k_{fg} is the radiation heat transfer coefficient. 0.65 is a constant for a bank of 10 or more tube rows (Incropera et al., 2007). Flue gas flow for the thermal decomposition rate of the fuel in Equation 30 is given by:

\dot{m}_{fg}=F_{Air}+\dot{m}_{gf}(N_{fg}−4.76·N_{O}_{₂}^{g})·22.41·10⁻³ [m³/s] (15)

where F_{Air} is the sum of the primary and secondary air flows (m³/s), whereas the flue gas temperature is calculated using:

T_{fg}=(q_{qf}+0.21(F_{Air}/(22.41·10⁻³·\dot{m}_{gf}))C_{O}_{₂}+0.79(F_{Air}/(22.41·10⁻³·\dot{m}_{gf})C_{N}_{₂}))/(n_{C}C_{CO}_{₂}+n_{S}C_{SO}_{₂}+(n_{H}_{₂}_{O}+N_{H}_{₂})C_{H}_{₂}_{O}+(3.76·N_{O}_{₂}^{g}+n_{N}_{₂})C_{N}_{₂}+0.21·N_{EAir}C_{O}_{₂}+0.79·N_{EAir}C_{N}_{₂}) (16)

where Cᵢ is the specific heat capacity of the component i (J/molT), and the N_{EAir} excess air (mol/kg). The energy balance for the tube walls is:

$$\frac{d {T}_{mt}}{d t} = \frac{1}{{m}_{m} {C}_{p}} ( {Q}_{fg} - {Q}_{s} ) [ K \text{/} s ] \qquad ( 17 )$$

where mₜ is the mass of the metal tubes (kg), and Cₚ is the specific heat of the metal (MJ/kgK). The heat transfer from the metal walls to the steam/water in the presence of convection heat transfer (superheaters) is provided by:

Qₛ=α_{c}\dot{m}₂^{0.8}(Tₘₜ−T) [MJ/s] (18)

where α_{c} is the convection heat transfer coefficient. The constant, 0.8, models the local Nusselt number for (hydrodynamically and thermally) fully developed turbulent flow by means of the Dittus-Boelter equation (Incropera et al., 2007; Winterton, 1998).

T=(T₁+T₂)/2[° C.] (19)

where T₁ is the input steam/water temperature (° C.) and T₂ the output steam/water temperature (° C.).

### The Synergy of the Combustion Power and the Fuel Moisture Soft-Sensors

The drawback of the original combustion power method is that the fuel moisture is assumed to be constant and known. Indeed, the thermal decomposition estimation (30) involves the amount of flue gas for one kg of fuel N_{fg}, which is disturbed by the fuel moisture as seen from (29). Therefore, substituting the fuel moisture estimation to (29) allows to achieve accurate calculations resulting in the correct estimation of the thermal decomposition rate. In addition, the combustion power calculation from the thermal decomposition rate is also affected by the moisture content of the fuel, as it is involved in the fuel heat value equation (2).

On the other hand, the fuel moisture soft-sensor fits the estimated and the measured steam enthalpy after the secondary superheater (13), which includes the heat transfer from the flue gas to the steam computed according to Equations from (34) to (36). In particular, the thermal decomposition rate is utilized in Equations (8) and (31), defining the flue gas flow and the temperature. Therefore, the fuel moisture estimation is impossible without providing the thermal decomposition rate. In other words, the fuel moisture cannot be derived if the power transferred to the steam-water circuit is known, but the fuel consumption rate is not.

### Dynamic Model of the BioGrate Boiler

The model describes the state of the furnace using the amount of dry fuel and the amount of water on the grate. The fuel moisture and the power demand are treated as measured disturbances, whereas the stoker speed and the primary air are considered as the inputs. The model predicts the fuel bed height, the combustion power and the drum pressure. The model, summarized in FIG. 5, consists of five submodels describing the dynamics of the fuel bed height, the amount of water in the furnace, the thermal decomposition rate, the combustion power and the drum pressure. The details of the submodels are presented in the following.

### The Model for the Fuel Bed Height and the Thermal Decomposition Rate

Devolatilization and char burnout take place in the region marked “thermal decomposition zone” in FIG. 6. The dynamics of the dry biomass m_{ds} is based on the thermal decomposition rate of the fuel \dot{m}_{thd}(t):

$$\frac{d {m}_{ds} ( t )}{d t} = - {\dot{m}}_{thd} ( t ) + {c}_{ds , in} {\dot{m}}_{ds , in} ( t ) [ kg \text{/} s ] \qquad ( 20 )$$

where c_{ds,in} is the correction coefficient identified from the data.

In (Bauer et al., 2010), the effect of the primary air flow rate on the thermal decomposition of the fuel is proportional. In this work, the model was modified to describe the fuel bed height effect on the thermal decomposition rate:

\dot{m}_{thd}=c_{thd}·\dot{m}ₚₐ·β_{thd}−c_{ds}·m_{ds} [kg/s] (21)

where c_{thd} is the thermal decomposition rate coefficient, \dot{m}ₚₐ is the primary air flow rate (m³/s), β_{thd} is the coefficient for a dependence on the position of the moving grate, c_{ds} is the fuel bed height coefficient, describing the mass of the fuel proportional to the density of the fuel. Nevertheless, with a constant fuel layer, the thermal decomposition rate increases linearly as the primary air flow rate increases, which is in agreement with (Bauer et al., 2010).

### The Model of Water Evaporation

In co-current combustion, most of the water evaporates in the region marked “moist fuel”, as shown in FIG. 6. The energy for the water evaporation is mainly provided by the combustion of char near the surface of the grate, but in the BioGrate it is also provided by the heat of thermal radiation from the brick walls. The temperature near the bottom of the char layer is almost independent of the primary air flow, thus the water evaporation rate was mainly independent of the primary air flow as well (Bauer et al., 2010). Therefore, the amount of water in the furnace is modeled as follows:

$$\frac{d {m}_{w} ( t )}{d t} = - {c}_{wev} {m}_{w} ( t ) {β}_{wev} ( t ) + {c}_{w , in} {\dot{m}}_{w , in} ( t - {t}_{d} ) [ kg \text{/} s ] \qquad ( 22 )$$

where m_{w}(t) is the mass of the water in the evaporation zone (kg), β_{wev} is the coefficient for a dependence on the position from the center to the periphery of the moving grate, c_{wev} and c_{w,in} are the model parameters estimated from the process data, and \dot{m}_{w,in} the moisture in the fuel feed (kg/s). The time delay is defined as

$${t}_{d} ( t ) = {c}_{td} \frac{{m}_{w} ( t )}{{\dot{m}}_{ds , in} ( t )} [ s ] \qquad ( 23 )$$

where c_{td} is the delay coefficient, and \dot{m}_{ds,in}(t) is the dry biomass flow rate (kg/s). The delay before the water starts to evaporate decreases as the amount of dry fuel increases. See FIG. 6.

### Combustion Power

The combustion power estimation considers the water evaporation and the thermal decomposition of the dry fuel separately:

\dot{Q}=q_{wf}\dot{m}_{thd}−0.0244\dot{m}_{wev} [MJ/s] (24)

### Drum Model

The drum level is kept constant by its controller, and therefore, the variations in the steam volume are neglected. Thus, the drum model is defined as (Åström & Bell, 2000):

$$\begin{matrix}\frac{d p}{d t} = \frac{1}{e} ( \dot{Q} - {\dot{m}}_{f} ( {h}_{w} - {h}_{f} ) - {\dot{m}}_{s} ( {h}_{s} - {h}_{w} ) ) & ( 25 ) \\ e \approx {ρ}_{w} {V}_{w} \frac{\partial {h}_{w}}{\partial p} + {m}_{m} {C}_{p} \frac{\partial {T}_{s}}{\partial p} & ( 26 )\end{matrix}$$

where \dot{Q} is the combustion power (MJ/s), \dot{m}_{f} is the feed water flow (kg/s), h_{w} is the specific enthalpy of the water (MJ/kg), h_{f} is the specific enthalpy of the feed water (MJ/kg), \dot{m}ₛ is the steam flow rate (kg/s), hₛ is the specific enthalpy of the steam (MJ/kg), ρ_{w} is the specific density of the water (kg/m³), V_{w} is the volume of the water (m₃), mₘ is the total mass of the metal tubes and the drum (kg), and Cₚ is the specific heat of the metal (MJ/kgK).

### Controller Reconfiguration

### Model-Based FDI for the BioGrate Boiler

### Generalized Model-Based FDI Strategy:

A discrete time linear stochastic system is considered

x(k+1)=Φx(k)+Γᵤu(k)+Γ_{w}w(k) (27)

y(k)=Cx(k)+v(k) (28)

where xεRⁿ represents state variables, uεR^{m} represents manipulated inputs, yεR^{r} represents measured output, and wεR^{q} and vεR^{r} represent the state and the measurement noise with known covariance matrices Q and R respectively. If no fault occurs, the Kalman filter is used to obtain the optimal estimates of the state variables as follows:

\hat{x}(k|k−1)=Φ\hat{x}(k−1|k−1)+Γᵤm(k−1); \hat{x}(0|0)=\hat{x}(0) (29)

\hat{x}(k|k)=\hat{x}(k|k−1)+K(k)v(k) (30)

v(k)=y(k)−C\hat{x}(k|k−1)

where m(k) represents the controller output and K(k) represents the Kalman gain matrix. Under a fault-free situation, the innovation v(k) is a zero mean Gaussian white noise process with covariance matrix V(k)

V(k)=CP(k|k−1)C^{T}+R (32)

where the matrix P(k|k−1) is obtained from the Kalman gain computations:

K(k)=P(k|k−1)C^{T}V⁻¹(k) (33)

P(k|k)=(I−K(k))C)P(k|k−1) (34)

P(k|k−1)=ΦP(k−1|k−1)Φ^{T}+Γ_{w}^{T}QΓ_{w} (35)

If a bias of magnitude b_{y,i} occurs at time instant t in the ith sensor, then the measurement output is given by

y(k)=Cx(k)+v(k)+b_{y,i}e_{y,i}σ(k−t) (36)

where e_{y,i} is a sensor fault vector with its ith element equal to unity and all other elements equal to zero, t represents the time of occurrence of the fault, and σ(k−t) is a unit step function defined as

$$σ ( k - t ) = \{ \begin{matrix}0 & if & k < t \\ 1 & if & k \geq t\end{matrix} \qquad ( 37 )$$

The occurrence of a fault at time t is detected if the test statistic ε(N;t) exceeds the threshold:

$$ɛ ( N ; t ) = {\sum }_{k = t}^{t + N} {v}^{T} ( k ) {V ( k )}^{- 1} v ( k ) \qquad ( 38 )$$

### Detection of Faults in the Fuel Bed Height Sensor:

Two state estimators FIG. 4 utilize fuel moisture soft-sensor and combustion power estimations, steam, temperature, drum pressure measurements, and alternatively fuel bed height measurement and calculated fuel bed height to filter the states of the system, FIG. 5. In order to detect faults in the fuel bed height sensor, its filtered calculated value is compared with the filtered measurement. The fuel bed height can be expressed from the primary air flow rate and the thermal decomposition rate Equation (21) as follows:

$${m}_{ds} = \frac{{c}_{thd} \cdot {\dot{m}}_{pa} \cdot {β}_{thd} - {\dot{m}}_{thd}}{{c}_{ds}} \qquad ( 39 )$$

If a bias of magnitude b_{y,i} occurs at time instant t in the ith sensor, then the measurement output for this sensor is given by

y(k)=Cx(k)+v(k)+b_{y,i}e_{y,i}σ(k−t) (40)

Furthermore, when a fuel bed height sensor fault occurs, the residual v(k) and the two state fuel bed height estimates \hat{x}(k|k) start to diverge from each other.

v(k)=y(k)−C\hat{x}(k|k−1) (41)

\hat{x}(k|k)=\hat{x}(k|k−1)+K(k)v(k); \hat{x}(0|0)=\hat{x}(0) (42)

The failure of the fuel bed height measurement is detected if the RMSEP exceeds the detection threshold:

$$RMSEP = \sqrt{\frac{{\sum }_{i = 1}^{n} {\vert {\hat{x} ( i )}_{1 , 1} - {\hat{x} ( i )}_{1 , 2} \vert}^{2}}{n}} \qquad ( 43 )$$

where n is the number of the samples in the test data set, \hat{x}(i)_{1,1} is the estimated fuel bed height of the first MPC configuration, and \hat{x}(i)_{1,2} the estimated fuel bed height of the second MPC configuration. The limit of detecting the faults is set above the normal disturbances of the states. Note that the fault isolation is implicitly done in the above fault detection procedure.

### MPC of the BioGrate Boiler

### Linear Discrete-Time MPC:

The MPC utilizes the linear state space system (Maciejowski, 2002):

x(k+1)=Ax(k)+Bu(k)+Ed(k)

y(k)=Cx(k) (44)

where A is the state matrix, B is the input matrix, E is the matrix for the measured disturbances, and C is the output matrix. According to (44), the k-step ahead prediction is formulated as:

$$y ( k ) = {CA}^{k} x ( 0 ) + {\sum }_{j = 0}^{k - 1} H ( k - j ) u ( j ) \qquad ( 45 )$$

where H(k−j) contains the impulse response coefficients. Therefore, using the Equation (2), the MPC optimization problem is:

$$min φ = \frac{1}{2} {\sum }_{k = 1}^{{N}_{p}} {‖ y ( k ) - r ( k ) ‖}_{{Q}_{z}}^{2} + \frac{1}{2} {‖ Δ u ( k ) ‖}_{{Q}_{u}}^{2} \\ s . t . x ( k + 1 ) = Ax ( k ) + Bu ( k ) + Ed ( k ) , \\ k = 0 , 1 , … , {N}_{p} - 1 \\ y ( k ) = Cx ( k ) , k = 0 , 1 , … , {N}_{p} \\ {u}_{min} \leq u ( k ) \leq {u}_{max} , k = 0 , 1 , … , {N}_{p} - 1 \\ Δ {u}_{min} \leq Δ u ( k ) \leq Δ {u}_{max} , k = 0 , 1 , … , {N}_{p} - 1 \\ {z}_{min} \leq y ( k ) \leq {z}_{max} , k = 1 , 2 , … , {N}_{p} \qquad ( 46 )$$

(46) where r is the target value and Δu(k)=u(k)−u(k−1).

The original system of Equation (44) is augmented with disturbance matrices to achieve the offset-free tracking in the presence of model-plant mismatch or unmeasured disturbances (Pannocchia & Rawlings, 2003).

$$\begin{matrix}[ \begin{matrix}x ( k + 1 ) \\ η ( k + 1 )\end{matrix} ] = [ \begin{matrix}A & {B}_{d} \\ 0 & {A}_{d}\end{matrix} ] [ \begin{matrix}x ( k ) \\ η ( k )\end{matrix} ] + [ \begin{matrix}B \\ 0\end{matrix} ] u ( k ) + [ \begin{matrix}E \\ 0\end{matrix} ] d ( k ) + [ \begin{matrix}ω ( k ) \\ ξ ( k )\end{matrix} ] & ( 47 ) \\ {y}_{k} = [ C {C}_{η} ] [ \begin{matrix}x ( k ) \\ η ( k )\end{matrix} ] + {υ}_{k} & ( 48 )\end{matrix}$$

The wₖ and vₖ are white noise disturbances with zero mean. Thus, the disturbances and the states of the system are estimated as follows:

$$[ \begin{matrix}\hat{x} ( k \vert k ) \\ \hat{η} ( k \vert k )\end{matrix} ] + [ \begin{matrix}\hat{x} ( k \vert k - 1 ) \\ \hat{η} ( k \vert k - 1 )\end{matrix} ] + [ \begin{matrix}{L}_{x} \\ {L}_{η}\end{matrix} ] ( y ( k ) - C \hat{x} ( ( k \vert k - 1 ) ) - {C}_{η} \hat{η} ( k \vert k - 1 ) ) \qquad ( 49 )$$

and the state predictions of the augmented system of Equation 18 are obtained by:

$$[ \begin{matrix}\hat{x} ( k + 1 \vert k ) \\ \hat{η} ( k + 1 \vert k )\end{matrix} ] = [ \begin{matrix}A & {B}_{d} \\ 0 & {A}_{d}\end{matrix} ] [ \begin{matrix}x ( k \vert k ) \\ η ( k \vert k )\end{matrix} ] + [ \begin{matrix}B \\ 0\end{matrix} ] u ( k ) + [ \begin{matrix}E \\ 0\end{matrix} ] d ( k ) \qquad ( 50 )$$

Additional disturbances, ηₖ, are not controllable by the inputs u. However, since they are observable, their estimates are used to remove their influence from the controlled variables. The disturbance model is defined by choosing the matrices B_{d} and C_{η}. Since the additional disturbance modes introduced by disturbance are unstable, it is necessary to check the detectability of the augmented system. The augmented system (Equation (18)) is detectable if and only if the nonaugmented system (Equation (44)) is detectable, and the following condition holds:

$$rank [ \begin{matrix}I - A & {B}_{d} \\ C & {C}_{η}\end{matrix} ] = n + {n}_{η} \qquad ( 51 )$$

In addition, if the system is augmented with a number of integrating disturbances n_{η} equal to the number of the measurements p (n_{η}=p) and if the closed-loop system is stable and constraints are not active at a steady state, there is zero offset in controlled variables.

### MPC for the BioGrate Boiler:

Defining the inputs u, states x, outputs y and the measured disturbances d according to FIG. 4, the process models of the BioGrate are summarized as follows:

$$\begin{matrix} \frac{d {x}_{1}}{d t} = {c}_{ds} {x}_{1} - {c}_{thd} {β}_{thd} {u}_{2} + {c}_{ds , in} {u}_{1} + {w}_{1} & ( 52 ) \\ \frac{d {x}_{2}}{d t} = - {c}_{wev} {β}_{wev} {x}_{2} + {c}_{w , in} {d}_{1} + {w}_{2} & ( 53 ) \\ \frac{d {x}_{3}}{d t} = - {x}_{3} + {q}_{wf} ( {c}_{thd} {β}_{thd} {u}_{2} - {c}_{ds} {x}_{1} ) - 0.0244 {c}_{wev} {β}_{wev} {x}_{2} + {w}_{3} & ( 54 ) \\ \frac{d {x}_{4}}{d t} = - {x}_{4} + {d}_{2} & ( 55 ) \\ \frac{d {x}_{5}}{d t} = \frac{1}{e} ( {x}_{3} - {x}_{4} ) + {w}_{4} & ( 56 ) \\ {y}_{1} = {x}_{1} + {v}_{1} & ( 57 ) \\ {y}_{2} = {x}_{3} + {v}_{2} & ( 58 ) \\ {y}_{3} = {x}_{5} + {v}_{3} & ( 59 )\end{matrix}$$

The following continuous-time state-space matrices are then discretized:

$$\begin{matrix}A = [ \begin{matrix}{c}_{ds} & 0 & 0 & 0 & 0 \\ 0 & - {c}_{wev} {β}_{wev} & 0 & 0 & 0 \\ - {q}_{wf} \cdot {c}_{ds} & - 0.0244 {c}_{wev} {β}_{wev} & - 1 & 0 & 0 \\ 0 & 0 & 0 & - 1 & 0 \\ 0 & 0 & 0.0020 & - 0.0020 & 0\end{matrix} ] & ( 60 ) \\ B = [ \begin{matrix}{c}_{ds , in} & - {c}_{thd} {β}_{thd} \\ 0 & 0 \\ 0 & {q}_{wf} {c}_{thd} {β}_{thd} \\ 0 & 0 \\ 0 & 0\end{matrix} ] & ( 61 ) \\ E = [ \begin{matrix}0 & 0 \\ {c}_{w , in} & 0 \\ 0 & 0 \\ 0 & 1 \\ 0 & 0\end{matrix} ] & ( 62 ) \\ C = [ \begin{matrix}1 & 0 & 0 & 0 & 0 \\ 0 & 0 & 1 & 0 & 0 \\ 0 & 0 & 0 & 0 & 1\end{matrix} ] & ( 63 )\end{matrix}$$

The designed system uses an input disturbance model where B_{d}=B, A_{d} is the unit matrix, and C_{η} is the zero matrix. The set points r₂ and r₃ for the combustion power and the drum pressure directly result from procedural considerations. The set point for the combustion power is calculated according to the steam demand and the drum pressure is kept constant. An important process parameter is λ_{fb} describing the ratio of primary air fed to the fuel bed and minimum amount of the air necessary for a complete combustion of fuel. From the amount of dry fuel in the thermal decomposition zone, the input variable \hat{m}ₚₐ and the constant parameters (c_{thd}, β_{thd}, c_{ds}), the set point r₁ for the mass of dry fuel in the thermal decomposition zone is calculated.

$${m}_{ds} = \frac{{c}_{thd} \cdot {\dot{m}}_{pa} \cdot {β}_{thd} - {\dot{m}}_{thd}}{{c}_{ds}} \qquad ( 64 )$$

Two different MPC configurations are developed for the process operating in two different modes, i.e. faultless or healthy mode and faulty mode. In the faultless mode, the primary air flow rate and the stoker speed are the manipulated variables (u); the moisture content in the fuel feed and the steam demand are the measured disturbances (d); and the fuel bed height and the steam pressure are the controlled variables (y). While for the faulty mode, the controlled variables are modified: i.e. the output y is composed of the fuel bed height, the combustion power and the steam pressure. Once the fault is detected and isolated using the scheme described, the controller is reconfigured from the healthy mode to the faulty mode.

### CONCLUSIONS

The embodiments of the invention providing a FTMPC strategy considering fuel quality and fuel moisture content has been developed for the BioPower 5 CHP process. First, the BioGrate process and its control strategy were presented. Then, a literature review in state-of-the-art control of grate boilers was presented. Second, the FTMPC for the BioGrate boiler and its modules were developed: The developed MPC utilizes combustion power and moisture soft-sensors and models of the water evaporation and thermal decomposition of dry fuel. Furthermore, the developed FTMPC accommodates the fault in a fuel bed height sensor by active controller reconfiguration. The fuel moisture soft-sensor was tested at the BioPower 5 CHP plant. Validation of models of the water evaporation and thermal decomposition of dry fuel was conducted using the measurements of the BioPower 5 CHP plant. Then the MPC strategy was compared with the currently used control strategy. Finally, the performance of the FTMPC was evaluated with the simulated BioGrate boiler.

The principles of the embodiments of the invention include: The availability and profitability of the BioPower 5 CHP process are improved by integration of fuel moisture content and combustion power estimations into a fault-tolerant model predictive control (FTMPC) scheme. This hypothesis has been verified by the results acquired in testing the fuel moisture soft-sensor by the industrial tests in the BioPower 5 CHP plant, testing the proposed MPC with the simulated BioGrate boiler, and testing the proposed FTMPC with the simulated BioGrate boiler.

First, the results showed that developed fuel moisture soft-sensor predicts the moisture content in the furnace with a good precision, and that the method was able to detect variations in the moisture content of the furnace within seconds. Second, it was shown that water evaporation and thermal decomposition of dry fuel can be estimated by utilizing fuel moisture soft-sensor and oxygen consumption calculations respectively. The fast settling time of 2 minutes in the response of the developed MPC strategy was achieved by regulating the primary air while keeping the fuel bed height at a desired level. In comparison, the settling time in the response of the currently used control strategy was 2 h. On the basis of the simulation results, the proposed FTMPC was able to counter the most typical fault in the BioPower 5 CHP plant that is caused by the unknown fuel quality and the status of the furnace (amount of fuel in the furnace). Therefore, the performance and the profitability of the BioPower 5 CHP plant would be significantly enhanced if such an FTMPC strategy is implemented.

The FTMPC outlined in this thesis has been developed for the BioGrate process. Nevertheless, due to its general applicability it could be used for other similar processes and thus the same advantages could be achieved in other plants regardless of the fuels and burning methods used. The greatest benefits can, however, be attained in plants fuelled with inhomogeneous fuels, such as peat, coal, bark and waste. In the future, the FTMPC can also play a major role in controlling, for example, the next generation of small-scale biomass boilers.

Thus, while there have been shown and described and pointed out fundamental novel features of the invention as applied to a preferred embodiment thereof, it will be understood that various omissions and substitutions and changes in the form and details of the method and device may be made by those skilled in the art without departing from the spirit of the invention. For example, it is expressly intended that all combinations of those elements and/or method steps which perform substantially the same results are within the scope of the invention. Substitutions of the elements from one described embodiment to another are also fully intended and contemplated. It is also to be understood that the drawings are not necessarily drawn to scale but they are merely conceptual in nature. It is the intention, therefore, to be limited only as indicated by the scope of the claims appended hereto.

### REFERENCES 1

[1] Bauer R, Grölles M, Brunner T, Dourdoumas N, Obernberger I. Modelling of grate combustion in a medium scale biomass furnace for control purposes. Biomass Bioenerg. 2010 April; 34(4):417-27.
[2] Lian Z T, Chua K J, Chou S K. A thermoeconomic analysis of biomass energy for trigeneration. Appl Energy. 2010 January; 87(1):84-95.
[3] Siitonen S, Tuomaala M, Suominen M, Ahtila P Implications of process energy efficiency improvements for primary energy consumption and CO₂ emissions at the national level. Appl Energy. 2010 September; 87(9):2928-37.
[4] Saastamoinen J J, Taipale R, Horttanainen M, Sarkomaa P Propagation of the ignition front in beds of wood particles. Combust and Flame. 2000 October; 123(1-2):214-26.
[5] Johansson R, Thunman H and Leckner B. Influence of intraparticle gradients in modeling of fixed bed combustion. Combust and Flame. 2007 April; 149(1-2):49-62.
[6] Yang Y B, Yamauchi H, Nasserzadeh V and Swithenbank J. Effects of fuel devolatilisation on the combustion of wood chips and incineration of simulated municipal solid wastes in a packed bed. Fuel. 2003 December; 82(18):2205-21.
[7] Yang Y B, Ryu C, Khor A, Yates N E, Sharifi V N and Swithenbank J. Effect of fuel properties on biomass combustion. Part II. Modelling approach-identification of the controlling factors. Fuel. 2005 November; 84(16):2116-30.
[8] Yang Y B, Ryu C, Khor A, Sharifi V N and Swithenbank J. Fuel size effect on pinewood combustion in a packed bed. Fuel. 2005 November: 84(16):2026-38.
[9] Thunman H, Leckner B. Ignition and propagation of a reaction front in cross-current bed combustion of wet biofuels. Fuel. 2001 March; 80(4):473-81.
[10] Thunman H, Leckner B. Co-current and counter-current fixed bed combustion of biofuel—a comparison. Fuel. 2003 February; 82(3):275-83.
[11] Boriouchkine A, Zakharov A, Jämsä-Jounela S-L. Dynamic modeling of combustion in a BioGrate furnace: The effect of operation parameters on biomass firing. Chem Eng Sci. 2012 February; 69(1):669-78.
[12] Kortela U, Lautala P. A New Control Concept for a Coal Power Plant. In: Proceedings of the 8th IFAC World Congress; 1981 Aug. 24-28; Kyoto, Japan.
[13] Kortela J, Jämsä-Jounela S-L. Fuel-quality soft sensor using the dynamic superheater model for control strategy improvement of the BioPower 5 CHP plant. Int J Electr Power Energy Syst. 2012 November; 42(1):38-48.
[14] Maciejowski J M. Predictive Control with Constraints. Harlow, England: Prentice Hal; 2002.
[15] Pannocchia G, Rawlings J B. Disturbance Models for Offset-Free Mode-Predictive Control. AIChE. 2003 February; 49(2):426-27.
[16] Kortela J, Jämsä-Jounela S-L. Fuel moisture soft-sensor and its validation for the industrial BioPower 5 CHP plant. Applied Energy. 2013 May; 105:66-74.

### REFERENCES 2

Anon2014wartsila2005 Anon 2014, BioGrate Technology, Available from: http://www.valmet.com [Accessed 1 Jun. 2014].
[Axrup et al.] Axrup, Markides Nilsson2000axrup2000 Axrup, L., Markides, K. Nilsson, T. 2000, ‘Using miniature diode array NIR spectrometers for analysing wood chips and bark samples in motion’, Journal of Chemometrics 14(5-6), 561-572.
Bak Clausen2002bak2002 Bak, J. Clausen, S. 2002, ‘FTIR emission spectroscopy methods and procedures for real time quantitative gas analysis in industrial environments’, Measurement Science and Technology 13(2), 150-156.
[Bauer et al.] Bauer, Gölles, Brunner, Dourdoumas Obernberger2010bauer2010 Bauer, R., Gölles, M., Brunner, T., Dourdoumas, N. Obernberger, I. 2010, ‘Modelling of grate combustion in a medium scale biomass furnace for control purposes’, Biomass and Bioenergy 34(4), 417-427.
Blasi2000diblasi2000 Blasi, C. D. 2000, ‘Dynamic behaviour of stratified downdraft gasifiers’, Chemical Engineering Science 55(15), 2931-2944.
[Boriouchkine et al.] Boriouchkine, Sharifi, Swithenbank Jämsä-Jounela2014boriouchkine2014 Boriouchkine, A., Sharifi, V., Swithenbank, J. Jämsä-Jounela, S.-L. 2014, ‘A study on the dynamic combustion behavior of a biomass fuel bed’, Fuel 135, 468-481.
[Edlund et al.] Edlund, Bendtsen Jørgensen2011edlund2011 Edlund, K., Bendtsen, J. D. Jørgensen, J. B. 2011, ‘Hierarchical model-based predictive control of a power plant portfolio’, Control Engineering Practice 19(10), 1126-1136.
Effenberger2000effenberger2000 Effenberger, H. 2000, Dampferzeuger, Springer-Verlag Berlin Heidelberg N.Y., pp 20-69.
[Frank et al.] Frank, Ding Marcu2000frank2000 Frank, P. M., Ding, S. X. Marcu, T. 2000, ‘Model-based fault diagnosis in technical processes’, Transactions of the institute of measurement and control 22(1), 57-101.
[Gölles et al.]Gölles, Bauer, Brunner, Dourdoumas Obernberge2011golles2011 Gölles, M., Bauer, R., Brunner, T., Dourdoumas, N. Obernberge, I. 2011, Model based control of a biomass grate furnace, in ‘Proceedings of the 9th European conference on industrial furnaces and boilers’, Estoril, pp. 1-10.
[Gölles et al.]Gölles, Reiter, Brunner, Dourdoumas Obernberger2014golles2014 Gölles, M., Reiter, S., Brunner, T., Dourdoumas, N. Obernberger, I. 2014, ‘Model based control of a small-scale biomass boiler’, Control Engineering Practice 22, 94-102.
[Gómez et al.]Gómez, Porteiro, Patiño Míguez2014gomez2014 Gómez, M. A., Porteiro, J., Patiño, D. Míguez, J. L. 2014, ‘CFD modelling of thermal conversion and packed bed compaction in biomass combustion’, Fuel 117(Part A), 716-732.
[Haghani et al.] Haghani, Jeinsch Ding2014haghani2014 Haghani, A., Jeinsch, T. Ding, S. X. 2014, ‘Quality-Related Fault Detection in Industrial Multimode Dynamic Processes’, IEEE Transactions on Industrial Electronics 61(11), 6446-6453.
[Hermansson et al.] Hermansson, Lind Thunman2011hermansson2011 Hermansson, S., Lind, F. Thunman, H. 2011, ‘On-line monitoring of fuel moisture-content in biomass-fired furnaces by measuring relative humidity of the flue gases’, Chemical Engineering Research and Design 89(11), 2470-2476.
[Incropera et al.] Incropera, DeWitt, Bergman Lavine2007incropera2007 Incropera, F. P., DeWitt, D. P., Bergman, T. L. Lavine, A. S. 2007, Fundamentals of Heat and Mass Transfer, John Wiley & Sons, pp 501-530.
[Jaakkola et al.] Jaakkola, Vahlman, Roos, Saarinen Kauppinen1998jaakkola1998 Jaakkola, P. T., Vahlman, T. A., Roos, A. A., Saarinen, P. E. Kauppinen, J. K. 1998, ‘On-line Analysis of Stack Gas Composition by a Low Resolution FT-IR Gas Analyzer’, Water, Air, and Soil Pollution 101(1-4), 79-92.
[Jegoroff et al.] Jegoroff, Leino Heiskanen2013jegoroff2013 Jegoroff, M., Leino, T. Heiskanen, V.-P. 2013, New method for controlling combustion in a grate boiler, in J. Kovács M. Hultgren, eds, ‘The proceedings of the 18th Nordic Process Control Workshop’, Oulu, Available from: http://www.nt.ntnu.no/users/skoge/prost/proceedings/npcw2 013/18th_NPCW_proceedings.pdf.
[Johansson et al.] Johansson, Thunman Leckner2007johansson2007 Johansson, R., Thunman, H. Leckner, B. 2007, ‘Influence of intraparticle gradients in modeling of fixed bed combustion’, Combustion and Flame 149(1-2), 49-62.
Kallioniemi2008kallioniemi2008 Kallioniemi, J. 2008, Utilising process monitoring methods in BioPower plant process, Master's thesis, Helsinki University of Technology, Espoo, pp 21-40.
Kettunen Jämsä-Jounela2011kettunen2011 Kettunen, M. Jämsä-Jounela, S.-L. 2011, ‘Data-Based, Fault-Tolerant Model Predictive Control of a Complex Industrial Dearomatization Process’, Industrial & Engineering Chemistry Research 50(11), 6755-6768.
Kohonen1990kohonen1990 Kohonen, T. 1990, ‘The self-organizing map’, Proceedings of the IEEE 78, 1464-1480.
Kortela Jämsä-Jounela2010kortela2010 Kortela, J. Jämsä-Jounela, S.-L. 2010, Fuel quality soft-sensor for control strategy improvement of the Biopower 5 CHP plant, in ‘Proceedings of the Conference on Control and Fault-Tolerant Systems (SysTol'10)’, Nice, pp. 221-226.
Kortela Lautala1982kortela1981 Kortela, U. Lautala, P. 1982, ‘A new control concept for a coal power plant’, Control Science and Technology for the Progress of Society 6, 3017-3023.
Kortela Marttinen1985kortela1985 Kortela, U. Marttinen, A. 1985, Modelling, Identification and Control of a Grate Boiler, in ‘Proceedings of the 1985 American Control Conference’, Boston, pp. 544-549.
[Lehtomäki et al.] Lehtomäki, Kortela Luukkainen1982lehtomaki1982 Lehtomäki, K., Kortela, U. Luukkainen, J. 1982, ‘New estimation and control methods for fuel power in peat power plants’, Control Science and Technology for the Progress of Society 6, 3039-3044.
[Leão et al.] Leão, Barroso, Sampaio, Almada, Lima, Rego Antunes2011leão2011 Leão, R. P. S., Barroso, G. C., Sampaio, R. F., Almada, J. B., Lima, C. F. P., Rego, M. C. O. Antunes, F. L. M. 2011, ‘The future of low voltage networks: Moving from passive to active’, International Journal of Electrical Power & Energy Systems 33(8), 1506-1512.
[Leskens et al.] Leskens, van Kessel Bosgra2005leskens2005 Leskens, M., van Kessel, L. B. M. Bosgra, O. H. 2005, ‘Model predictive control as a tool for improving the process operation of MSW combustion plants’, Waste Management 25(8), 788-798.
[Li et al.] Li, Yue, Valle-Cervantes Qin2000li2000 Li, W., Yue, H. H., Valle-Cervantes, S. Qin, S. J. 2000, ‘Recursive pca for adaptive process monitoring’, Journal of Process Control 10, 471-486.
Lu1999lu1999 Lu, S. 1999, ‘Dynamic modelling and simulation of power plant systems’, Proceedings of the Institution of Mechanical Engineers, Part A: Journal of Power and Energy 213(1), 7-22.
Lu Hogg2000lu2000 Lu, S. Hogg, B. W. 2000, ‘Dynamic nonlinear modelling of power plant by physical principles and neural networks’, International Journal of Electrical Power & Energy Systems 22(1), 67-78.
Maciejowski2002maciejowski2002 Maciejowski, J. M. 2002, Predictive Control with Constraints, Prentice Hall, Harlow, pp 36-150.
Nordell Vikterlöf2000nordell2000 Nordell, A. Vikterlöf, K. J. 2000, Measurements of moisture content in wood fuels with dual energy X-ray, Värmeforsk, Stockholm, Available from: http://www.varmeforsk.se [Accessed 1 Jun. 2014].
Nyström Dahlquist2004nystrom2004 Nyström, J. Dahlquist, E. 2004, ‘Methods for determination of moisture content in woodchips for power plants—a review’, Fuel 83(7-8), 773-779.
Okamura Zhang2000okamura2000 Okamura, S. Zhang, Y. 2000, ‘New method for moisture content measurement using phase shifts at two microwave frequencies’, Journal of Microwave Power and Electromagnetic Energy 35(3), 175-178.
[Paces et al.] Paces, Voigt, Jakubek, Schirrer Kozek2011pacess2011 Paces, N., Voigt, A., Jakubek, S., Schirrer, A. Kozek, M. 2011, Combined Control of Combustion Load and Combustion Position in a Moving Grate Biomass Furnace, in ‘Proceedings of the 19th European Conference on Control & Automation (MED)’, Corfu, pp. 1447-1452.
Pannocchia Rawlings2003pannocchia2003 Pannocchia, G. Rawlings, J. B. 2003, ‘Disturbance Models for Offset-Free Model-Predictive Control’, AIChE Journal 49(2), 426-437.
[Patwardhan et al.] Patwardhan, Manuja, Narasimhan Shah2006patwardhan2006 Patwardhan, S. C., Manuja, S., Narasimhan, S. Shah, S. L. 2006, ‘From data to diagnosis and control using generalized orthonormal basis filters. Part II: Model predictive and fault tolerant control’, Journal of Process Control 16(2), 157-175.
[Prakash et al.] Prakash, Patwardhan Narasimhan2002prakash2002 Prakash, J., Patwardhan, S. C. Narasimhan, S. 2002, ‘A Supervisory Approach to Fault-Tolerant Control of Linear Multivariable Systems’, Industrial & Engineering Chemistry Research 41(9), 2270-2281.
Qin1998qin1998 Qin, S. J. 1998, ‘Recursive pls algorithms for adaptive data modeling’, Computers and Chemical Engineering 22(4), 503-514.
[Rosenberg et al.] Rosenberg, Schatvet Høydal2001rosenberg2001 Rosenberg, E., Schatvet, J. Høydal, K. 2001, In-kiln measurements of moisture content in timber at moelven våler as., in ‘Proceedings of the 3rd European Cost E15 Workshop on Wood Drying: With the Theme Softwood Drying to Meets Needs of Further Processing and Specific End-uses’, Helsinki, pp. 1-9.
[Saastamoinen et al.] Saastamoinen, Taipale, Horttanainen Sarkomaa2000saastamoinen2000 Saastamoinen, J. J., Taipale, R., Horttanainen, M. Sarkomaa, P. 2000, ‘Propagation of the ignition front in beds of wood particles’, Combustion and Flame 123(1-2), 214-226.
[Sourander et al.] Sourander, Vermasvuori, Sauter, Liikala Jämsä-Jounela2009sourander2009 Sourander, M., Vermasvuori, M., Sauter, D., Liikala, T. Jämsä-Jounela, S.-L. 2009, ‘Fault tolerant control for a dearomatisation process’, Journal of Process Control 19(7), 1091-1102.
Ström Thunman2013thunman2013 Ström, H. Thunman, H. 2013, ‘A computationally efficient particle submodel for CFD-simulations of fixed-bed conversion’, Applied Energy 112, 808-817.
Åström Bell2000astrom1999 Åström, K. J. Bell, R. D. 2000, ‘Drum-boiler dynamics’, Automatica 36(3), 363-378.
Thunman Leckner2001thunman2001 Thunman, H. Leckner, B. 2001, ‘Ignition and propagation of a reaction front in cross-current bed combustion of wet biofuels’, Fuel 80(4), 473-481.
Thunman Leckner2003thunman2003 Thunman, H. Leckner, B. 2003, ‘Co-current and counter-current fixed bed combustion of biofuel—a comparison’, Fuel 82(3), 275-283.
[van der Lans et al.] van der Lans, Pedersen, Jensen, Glarborg Dam-Johansen2000lans2000 van der Lans, R. P., Pedersen, L. T., Jensen, A., Glarborg, P. Dam-Johansen, K. 2000, ‘Modelling and experiments of straw combustion in a grate furnace’, Biomass and Bioenergy 19(3), 199-208.
[Venkatasubramanian et al.] Venkatasubramanian, Rengaswamy, Yin Kavuri2003venkatasubramanian2003 Venkatasubramanian, V., Rengaswamy, R., Yin, K. Kavuri, S. N. 2003, ‘A review of process fault detection and diagnosis: Part I: Quantitative model-based methods’, Computers & Chemical Engineering 27(3), 293-311.
Winterton1998winterton1998 Winterton, R. H. S. 1998, ‘Where did the dittus and boelter equation come from?’, International Journal of Heat and Mass Transfer 41(4-5), 809-810.
[Yang et al.] Yang, Ryu, Khor, Yates, Sharifi Swithenbank2005ayang2005b Yang, Y. B., Ryu, C., Khor, A., Yates, N. E., Sharifi, V. N. Swithenbank, J. 2005a, ‘Effect of fuel properties on biomass combustion. Part II. Modelling approach—identification of the controlling factors’, Fuel 84(16), 2116-2130.
[Yang et al.] Yang, Ryu, Khor, Yates, Sharifi Swithenbank2005byang2005 Yang, Y. B., Ryu, C., Khor, A., Yates, N. E., Sharifi, V. N. Swithenbank, J. 2005b, ‘Fuel size effect on pinewood combustion in a packed bed’, Fuel 84(16), 2026-2038.
[Yang et al.] Yang, Yamauchi, Nasserzadeh Swithenbank2003yang2003 Yang, Y. B., Yamauchi, H., Nasserzadeh, V. Swithenbank, J. 2003, ‘Effects of fuel devolatilisation on the combustion of wood chips and incineration of simulated municipal solid wastes in a packed bed’, Fuel 82(18), 2205-2221.
[Yin et al.] Yin, Rosendahl Kær2008pa Yin, C., Rosendahl, L. A. Kær, S. K. 2008, ‘Grate-firing of biomass for heat and power production’, Progress in Energy and Combustion Science 34(6), 725-754.
Zhang Jiang2008zhang2008 Zhang, Y. Jiang, J. 2008, ‘Bibliographical review on reconfigurable fault-tolerant control systems’, Annual Reviews in Control 32(2), 229-252.
[Zheng et al.] Zheng, Patton Chen1997zheng1997 Zheng, C., Patton, R. J. Chen, J. 1997, Robust fault-tolerant systems synthesis via LMI, in ‘IFAC Safeprocess '97’, pp. 347-352.
Kortela, J., Jämsä-Jounela, S.-L. (2012) Fuel-quality soft sensor using the dynamic superheater model for control strategy improvement of the BioPower 5 CHP plantInternational Journal of Electrical Power & Energy Systems42 (1)38-48Elsevierj1 J. Kortela developed a method for estimating thermal decomposition of fuel and fuel moisture in a furnace, and the use of the method in the control strategy improvement of the BioPower 5 CHP plant. He also developed the simulator, performed all simulation tests, analyzed the results, and wrote the manuscript under the supervision of Prof. S.-L. Jämsä-Jounela. dummyarticles/dummypdfarticle1.pdf
Kortela, J., Jämsä-Jounela, S.-L. (2013) Fuel moisture soft-sensor and its validation for the industrial BioPower 5 CHP plantApplied Energy10566-74Elsevierj2 J. Kortela developed a soft-sensor for the on-line monitoring of fuel moisture in a furnace. To verify the fuel moisture soft-sensor, the industrial tests were performed by J. Kortela, A. Boriouchkine, MW Power Oy, and Technical Research Centre of Finland (VTT). J. Kortela analyzed the results, and wrote the manuscript. dummyarticles/dummypdfarticle1.pdf Kortela, J., Jämsä-Jounela, S.-L. (2015) Modeling and model predictive control of the BioPower combined heat and power (CHP) plantInternational Journal of Electrical Power & Energy Systems65453-462Elsevierj3 J. Kortela developed the model predictive control (MPC) strategy, where the combustion model is based on the mass balances for water and dry fuel. In addition, he identified the models for the BioPower combined heat and power (CHP) plant. He also implemented the MPC code, performed all the simulation tests, analyzed the results, and wrote the manuscript. dummyarticles/dummypdfarticle1.pdf Kortela, J., Jämsä-Jounela, S.-L. (2014) Model predictive control utilizing fuel and moisture soft-sensors for the BioPower 5 combined heat and power (CHP) plantApplied Energy131189-200Elsevierj4 J. Kortela developed the fuel bed height model for the BioGrate boiler. To verify the fuel bed height model, the industrial tests were performed by J. Kortela, A. Boriouchkine, MW Power Oy, and Technical Research Centre of Finland (VTT). In addition, J. Kortela developed the model predictive control (MPC) strategy that utilizes the fuel bed height model. He also performed all the simulation tests, analyzed the results, and wrote the manuscript. dummyarticles/dummypdfarticle1.pdf [submitted] Kortela, J., Jämsä-Jounela, S.-L. (2014) Fault-tolerant model predictive control (FTMPC) for the BioGrate boiler Applied Energy Submitted the 1st of December, 2014Elsevierj5 The amount of fuel on the grate needs to be held close to the set point for the correct primary and secondary air ratio. Therefore the fuel bed height sensor is critical element in the control of the BioGrate boiler. J. Kortela developed the fault-tolerant model predictive control (FTMPC) to accommodate the fault in this fuel bed height sensor by active controller reconfiguration. He also implemented the FTMPC code, performed all the simulation tests, analyzed the results, and wrote the manuscript. dummyarticles/dummypdfarticle1.pdf

1. A method, comprising:
receiving sensor input concerning a thermal decomposition rate and water evaporation rate of fuel moisture;
based at least in part on the sensor input and a mathematical model, modelling a performance of a boiler, and
determining, based at least in part on the modelling, control instructions to control functioning of the boiler, the control instructions being configured to cause compensation for disturbances caused by variations in at least one of a fuel quality and a fuel bed in the boiler.

2. The method according to claim 1, wherein the control instructions are configured to cause controlling of at least one of a primary air supply and a stoker speed, when supplied to the boiler.

3. The method according to claim 1, wherein the control instructions are configured to cause controlling of a secondary air supply.

4. The method according to claim 1, wherein the modelling comprises determining a fuel bed height, and the determining comprises determining control instructions that increase the primary air supply responsive to a determination that a fuel bed height in the boiler has increased.

5. The method according to the claim 1, wherein, after determination of water evaporation, estimating the amount of moisture in boiler so that the moment when the moisture begins to evaporate from the fuel the boiler can be estimated.

6. The method according to the claim 1, wherein the effect of evaporating moisture in the power produced is deducted and at least one of the stoker speed and primary air feed is controlled accordingly.

7. The method according to claim 1, wherein the control instructions are determined, based on the modelling, to cause controlling of the primary air supply to keep a fuel bed height at a desired level.

8. The method according to claim 1, wherein the determining is based at least in part on at least one of a target fuel bed height, a target steam pressure and a target combustion power.

9. The method according to claim 4, wherein in the modelling the fuel bed height is determined based on a first equation where a time derivative of the thermal decomposition rate is equal to a time derivative of a primary air flow multiplied by a thermal decomposition rate coefficient, from which a dry biomass multiplied by a fuel bed height coefficient is subtracted to obtain the time derivative of the thermal decomposition rate.

10. The method according to claim 4, wherein a fuel bed height is obtained from a pressure sensor and from the modelling based on a primary air supply rate independently of each other.

11. The method according to claim 10, further comprising determining whether the pressure sensor has malfunctioned based on a comparison of the fuel bed height obtained from the pressure sensor to the fuel bed height obtained from the modelling.

12. An apparatus, comprising:
a receiver configured to receive sensor input concerning a thermal decomposition rate and water evaporation rate of fuel moisture, and
at least one processing core configured to model, based at least in part on the sensor input and a mathematical model, a performance of a boiler, and to determine, based at least in part on the modelling, control instructions to control functioning of the boiler, the control instructions being configured to cause compensation for disturbances caused by variations in at least one of a fuel quality and a fuel bed in the boiler.

13. The apparatus according to claim 12, wherein the control instructions are configured to cause controlling of at least one of a primary air supply and a stoke speed, when supplied to the boiler.

14. The apparatus according to claim 12, wherein the control instructions are configured to cause controlling of a secondary air supply.

15. The apparatus according to claim 12, wherein the modelling comprises determining a fuel bed height, and the determining comprises determining control instructions that increase the primary air supply responsive to a determination that a fuel bed height in the boiler has increased.

16. The apparatus according to claim 12, wherein the at least one processing core is configured to determine the control instructions, based on the modelling, to cause controlling of the primary air supply to keep a fuel bed height at a desired level.

17. The apparatus according to claim 12, further comprising elements for determination of water evaporation and estimating the amount of moisture in boiler so that the moment when the moisture begins to evaporate from the fuel the boiler can be estimated.

18. The apparatus according to claim 12, further comprising elements deducting the effect of evaporating moisture in the power produced and for controlling at least one of the stoker speed and primary air feed accordingly.

19. The apparatus according to claim 12, wherein the at least one processing core is configured to determine the control instructions based at least in part on at least one of a target fuel bed height, a target steam pressure and a target combustion power.

20. The apparatus according to claim 12, wherein in the modelling the fuel bed, height is determined based on a first equation where a time derivative of the thermal decomposition rate is equal to a time derivative of primary air flow rate multiplied by a thermal decomposition rate coefficient, from which a dry biomass multiplied by a fuel bed height coefficient is subtracted to obtain the time derivative of the thermal decomposition rate.

21. The apparatus according to claim 12, wherein the at least one processing core is configured to obtain a fuel bed height from a pressure sensor and from the modelling based on a primary air supply rate independently of each other.

22. The apparatus according to claim 12, wherein the at least one processing core is further configured to determine whether the pressure sensor has malfunctioned based on a comparison of the fuel bed height obtained from the pressure sensor to the fuel bed height obtained from the modelling.

23. (canceled)

24. A non-transitory computer readable medium having stored thereon a set of computer readable instructions that, when executed by at least one processor, cause an apparatus to at least:
receive sensor input concerning a thermal decomposition rate and a fuel moisture;
based at least in part on the sensor input and a mathematical model, model a performance of a boiler, and
determine, based at least in part on the modelling, control instructions to control functioning of the boiler, the control instructions being configured to cause compensation for disturbances caused by variations in at least one of a fuel quality and a fuel bed in the boiler.

25. (canceled)
